(19) United States
(12) Patent Application Publication
(10) Pub. No.: US 2018/0273819 A1
(43) Pub. Date: Sep. 27, 2018

(54) THERMAL ENERGY STORAGE PHASE AND TEMPERATURE STABILIZATION CHANGE MATERIALS COMPRISING TRIAMINES AND METHODS FOR MAKING AND USING THEM

(71) Applicant: ENTROPY SOLUTIONS, LLC., Plymouth, MN (US)

(72) Inventors: William Rusty SUTTERLIN, Hoover, AL (US); Andre Arvin WILLIAMS, Tuscaloosa, AL (US)

(21) Appl. No.: 15/571,235

(22) PCT Filed: Apr. 29, 2016
(86) PCT No.: PCT/US2016/030225

§ 371 Date: Nov. 1, 2017

Related U.S. Application Data
(60) Provisional application No. 62/156,212, filed on May 2, 2015.
(60) Provisional application No. 62/156,213, filed on May 2, 2015.
(60) Provisional application No. 62/232,290, filed on Sep. 24, 2015.

(51) Int. Cl. C09K 5/06; F16L 59/00

(52) U.S. Cl. CPC C09K 5/063; F16L 59/00

(57) ABSTRACT

This invention generally relates to phase change materials, thermoregulation, thermal protection and insulation. In particular, in alternative embodiments, provided are organic Phase Change Materials having different chemical moieties including triamines, nitriles, anhydrides and/or benzoic acid and combinations thereof. In alternative embodiments, provided are Phase Change Material (PCMs) compositions and products of manufacture comprising triamines, nitriles, anhydrides, and/or benzoic acids, and methods for making and using them. In alternative embodiments, the Phase Change Material (PCMs) compositions and products of manufacture are used for thermal energy management and temperature stabilization in various applications such as building and insulation materials, automotive, airline, weapons systems, computers and electronics, clothing, packaging, cookware, garment and footwear, pharmaceuticals and drug storage systems, and other food and energy storage and temperature stabilization systems.

### RELATED APPLICATIONS

This application claims the benefit of priority to international patent application serial number PCT/US2016/030225, filed Apr. 29, 2016, which claims benefit of priority to U.S. Provisional Patent Application Ser. No. 62/156,213, filed May 2, 2015; U.S. Ser. No. 62/156,212, filed May 2, 2015; and U.S. Ser. No. 62/232,290, filed Sep. 24, 2015. The aforementioned applications are expressly incorporated herein by reference in their entirety and for all purposes.

### TECHNICAL FIELD

This invention generally relates to phase change materials, thermoregulation, thermal protection and insulation. In particular, in alternative embodiments, provided are organic Phase Change Materials (PCMs) having different chemical moieties including triamines, nitriles, anhydrides and/or benzoic acid. In alternative embodiments, provided are Phase Change Material compositions, formulations and products of manufacture comprising triamines, nitriles, anhydrides, or benzoic acid, and methods for making and using them. In alternative embodiments, the Phase Change Material (PCMs) compositions, formulations and products of manufacture are used for thermal energy management and temperature stabilization in various applications such as building and insulation materials, automotive, airlines, boats, electronics and computers and their storage facilities or compartments, weapons systems, packaging and storage materials and compartments, clothing, garment and footwear, and other energy storage and temperature stabilization systems.

### BACKGROUND OF THE INVENTION

There is a general desire in all industries to increase energy efficiency. There is also a general desire to reduce the use of fossil fuel resources due to concerns over climate change and energy security. Buildings, for example, require significant amounts of energy for heating and cooling and there is a need to reduce the costs associated with thermal management. The thermal management of temperature sensitive payloads during transport can also require significant amounts of energy. In the automotive industry, there is a desire to increase efficiency and reduce the fuel usage associated with maintaining a comfortable temperature in the cabin of vehicles. In the textile industry, in particular for life and personal protection clothing, there is a desire to create fabrics and materials that maintain the temperature of the wearer in a comfortable range by removing excess heat.

One approach of decreasing the amount of energy needed for thermal management is the use of phase change materials. A “phase change material” (PCM) is a material that stores or releases a large amount of energy during a change in state, or “phase”, e.g. crystallization (solidifying) or melting (liquefying) at a specific temperature. The amount of energy stored or released by a material during crystallization or melting, respectively, is the latent heat of that material. During such phase changes, the temperature of the material remains relatively constant. This is in contrast to the “sensible” heat, which does result in a temperature change of the material, but not a phase change.

PCMs are therefore “latent” thermal storage materials. A transfer of energy occurs when the material undergoes a phase change, e.g. from a liquid to a solid and thus helps to maintain the temperature of a system. When heat is supplied to the system in which the temperature is at the melting point of the PCM, energy will be stored by the PCM, resulting in a mediating effect on the temperature of the system. Similarly, when the temperature of the system decreases to the crystallization temperature of the PCM, the energy stored by the PCM will be released into the surrounding environment. The amount of energy stored or released by a material is a constant, and is that material's latent heat value. For example, water has a latent heat of 333 J/g. Therefore, a gram of water will release 333 J of energy to its surrounding environment during crystallization (freezing), at 0° C. without changing temperature. Similarly, a gram of frozen water will absorb 333 J of energy from its surrounding environment during melting without an increase in temperature from 0° C.

There are two primary characteristics that must be considered for a specific application of a PCM: 1) the melting/crystallization temperature of the material, and 2) the latent heat value. A high latent heat value is the most desirable characteristic of a phase change material. A high latent heat value means that the material will be able to store or release large amounts of energy during a phase change, thus reducing the quantity of supplied energy needed to heat or cool a system. A latent heat value of 130 J/g or higher is considered acceptable for a PCM material in thermal storage applications. The melting/crystallization temperature is important because every thermal storage system has a unique optimal temperature range. These two factors together inform the potential applications for a specific PCM. For example, although water has a very high latent value (333 J/g), it would not be suitable for use as a PCM in building materials, as buildings are typically maintained at temperatures around 70° C., well above the melting/crystallization temperature of water.

The majority of commercially available PCMs are salt hydrates or paraffins. Both salt hydrates and paraffins have inherent disadvantages in commercial applications. Salt hydrates, while cheap to produce, have inconsistent melting points, and have a tendency to supercool. Salt hydrates are also known to undergo significant thermal expansion and can be highly toxic and corrosive. Paraffins make suitable PCMs in that they have favorable latent heat values and consistent melting points. However, the high latent heats of paraffin-based PCMs (in excess of 230 J/g) require compositions comprising high purities of paraffins, necessitating the use of expensive processing technology. Further, paraffins are limited in their potential range of phase change temperatures, leading to the use of mixed PCM compositions with reduced latent heat values.

Other concerns with paraffins used as PCMs are social dynamics. Paraffins are made from petroleum products, which increases our reliance on crude oil. Paraffin prices have followed the unstable price of petroleum. Furthermore, petroleum derived paraffins have geopolitical consequences and contribute to the increase in carbon emissions blamed for the global warming crisis.

The widespread use of traditional PCMs has been further limited due to concerns over flammability. For example, the use of paraffin or vegetable oil-derived PCMs has been limited due to the inherent flammability of many of these materials. A need thus remains for PCMs with high latent heat and other favorable thermal storage properties that can be used in thermal energy storage systems across a broad range of temperatures.

### SUMMARY OF THE INVENTION

In alternative embodiments, provided are compositions, products of manufacture, and thermal energy storage (TES) or temperature stabilization compounds and systems, comprising:
a Phase Change Material (PCM) compound selected from the group consisting of:
   a triamine or triamine acid derivative; a nitrile or nitrile derivative; an anhydride or anhydride derivative; a benzoic acid or benzoic acid derivative; and a combination thereof;
   wherein optionally the PCM comprises: a triamine and a nitrile, a triamine and an anhydride, a triamine and a benzoic acid, a nitrile and an anhydride; a nitrile and a benzoic acid, an anhydride and a benzoic acid,
   wherein optionally the PCM comprises: a triamine; a nitrile; an anhydride; and a benzoic acid,
wherein the phase change material compound is capable of undergoing a solid to liquid and a liquid to solid phase change transition.

In alternative embodiments, the triamine or triamine acid derivative comprises an alkyl triamine or an aromatic triamine, or the triamine is selected from the group consisting of: a polyetheramines, an N-(2-Aminoethyl)-1,3-propanediamine, a spermidine, bis(hexamethylene)triamine, a 3,3-diamnopropylamine and a combination thereof, and optionally the triamine or triamine acid derivative, optionally a trialkyl amine, has a latent heat of fusion in the range of between about 186 and 257 J/g.

In alternative embodiments, the nitrile or nitrile derivative is selected from the group consisting of: mononitriles, dinitriles, trinitriles, polynitriles and a combination thereof, and optionally the nitrile or nitrile derivative, optionally an alkyl nitrile, has a latent heat of fusion in the range of between about 190 and 233 J/g.

In alternative embodiments, the nitrile or nitrile derivative is, or comprises, an alkyl nitrile; or, the nitrile or nitrile derivative is, or comprises, an aromatic nitrile; or, the nitrile or nitrile derivative is selected from the group consisting of: tetradecanonitrile, heptadecanonitrile, nonadecanenitrile, dodecanenitrile and a combination thereof.

In alternative embodiments, the nitrile or nitrile derivative is synthesized via a Kolbe nitrile synthesis method, or the nitrile or nitrile derivative is synthesized via a CSI method.

In alternative embodiments, the wherein PCM compound comprises an anhydride or anhydride derivative, and optionally the anhydride or anhydride derivative has a latent heat of fusion in the range of between about 190 and 233 J/g.

In alternative embodiments, the anhydride or anhydride derivative is selected from the group consisting of:

(a) an organic acid anhydride, an alkyl anhydride, an aryl anhydride, a symmetrical anhydride, a (mixed) unsymmetrical anhydride, a polyanhydride and a combination thereof;

(b) an alkyl anhydride, optionally where R1 and R2 are independently the same or a different alkyl or aryl group of groups:

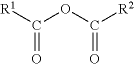

(c) an aryl anhydride where the ‘R’ groups independently are: a hydrogen, an alkyl group, an aryl group, an amino group, a hydroxyl group, a halide, and a functional group; or, an alkyl anhydride comprising two aliphatic chains, where optionally ‘n’ is between 0 to 28:

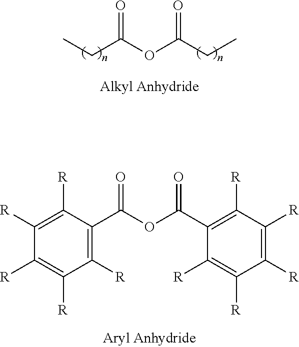

and

(d) any combination of (a) to (c).

In alternative embodiments, the anhydride or anhydride derivative comprises: an acetic anhydride, a hexanoic anhydride, an octanoic anhydride, a decanoic anhydride, a dodecanoic anhydride, an octadecanoic anhydride, a cosanoic anhydride, a docosanoic anhydride, a hexacosanoic anhydride, or a tricosanioc anhydride.

In alternative embodiments, the anhydride or anhydride derivative comprises: aryl (benzoic) anhydrides e.g. benzoic anhydride, 4-nitrobenzoic anhydride, perfluorobenzoic anhydride, 4-chlorobenzoic anhydride, 3-chlorobenzoic anhydride, 2-chlorobenzoic anhydride, 4-methoxybenzoic anhydride, 3,4-dimethoxybenzoic anhydride, 3,4,5-trimethoxybenzoic anhydride, 2,6-dichlorobenzoic anhydride, 3,5-dichlorobenzoic anhydride, 2-methylbenzoic anhydride, 3-methylbenzoic anhydride, 4-methylbenzoic anhydride, 4-aminobenzoic anhydride, 4-dimethylaminobenzoic anhydride, 3-dimethylaminobenzoic anhydride, 4-fluorobenzoic anhydride, 2-fluorobenzoic anhydride, 2-bromobenzoic anhydride, 4-bromobenzoic anhydride, 3-trifluoromethylbenzoic anhydride, 4-trifluoromethylbenzoic anhydride, 2-methyl-6-nitrobenzoic anhydride, or 2-amino-6-methylbenzoic anhydride.

In alternative embodiments, the benzoic acid or benzoic acid derivative comprises a compound in the range of between about 137 to 753 J/g. In alternative embodiments, the benzoic acid or benzoic acid derivative is selected from the group consisting of:

(a) a benzoic acid having the formula:

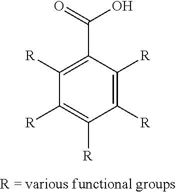

wherein the R functional groups independently are: a carboxy, ester, amide, hydroxyl, halide, ether, alkyl, phenyl, amino, cyano, nitro, and a thiol group, and optionally the benzene ring is substituted with 2 to 6 similar or different substituents;

(b) a 2-hydroxybenzoic acid, 3-hydroxybenzoic acid. 4-hydroxybenzoic acid, 4-amino-2-hydroxybenzoic acid, 5-amino-2-hydroxybenzoic acid, 3-amino-2-methoxybenzoic acid, 2-hydroxy-5-nitrobenzoic acid, 2-chloro-5-nitrobenzoic acid, 3,5-dinitro-2-hydroxybenzoic acid, 2-hydroxy-3-methylbenzoic acid, 2-hydroxy-5-nitrobenzoic acid, 4-cyanobenzoic acid, 2-acetoxybenzoic acid, 3-acetoxybenzoic acid, 3-methoxy-4-methylbenzoic acid, 4-dimethylaminobenzoic acid, 3-methoxybenzoic acid, 3,4-dimethoxybenzoic acid, 3,5-dimethylbenzoic acid, 1,2-benzenedicarboxylic acid, 1,2,4-benzenetricarboxylic acid, or 1,2,4,5-benzenetetracarboxylic acid;

(c) an anthranilic acid, a 2,4-dihydroxybenzoic acid, or 2-sulfobenzoic acid; and

(d) any combination of (a) to (c).

In alternative embodiments, provided are nanoparticles, microparticles, macroparticles, liposomes, capsules, and microcapsules comprising a phase change material-comprising composition as provided herein, wherein optionally the nanoparticle, microparticle, macroparticle, liposome, capsule or microcapsule is multilayered (e.g., bilayered, trilayered), optionally with a different phase change material-comprising composition in each different layer. In alternative embodiments, the nanoparticle, microparticle, macroparticle, liposome, capsule or microcapsule has an outer shell and has an interior (e.g., is hollow, has an interior space), wherein the interior contains one or more PCM compositions or compounds of the invention.

In alternative embodiments, provided are an article of manufacture, a product of manufacture, a coating, a liquid, a gel, an antifreeze fluid, a fluid, an ink, an oil, a lubricant, a sealant, a paint, a textile, a cloth, a clothing, an upholstered furniture, a matting, a bedding or bedding system, a pharmaceutical or drug delivery system, a food or a food storage system, an electronic or computer hardware or systems or storage facilities or compartments, or a weapons system or storage facilities, comprising: a phase change material-comprising composition as provided herein, or a nanoparticle, a microparticle, a macroparticle, a liposome, a capsule, or a microcapsule as provided herein.

In alternative embodiments, provided are a building or an insulation material, an automotive or boat or airline material, a packaging material, a garment, a footwear or a footwear material, weapons systems, computers and electronics, or an energy storage or temperature stabilization system, comprising: a phase change material-comprising composition as provided herein, or a nanoparticle, a microparticle, a macroparticle, a liposome, a capsule, or a microcapsule as provided herein.

The details of one or more embodiments of the invention are set forth in the accompanying drawings and the description below. Other features, objects, and advantages of the invention will be apparent from the description and drawings, and from the claims. All publications, patents, patent applications cited herein are hereby expressly incorporated by reference for all purposes.

### BRIEF DESCRIPTION OF THE DRAWINGS

For a more accurate understanding of the present invention, reference is now made to the following description in conjunction with the accompanying drawing, in which:

FIG. 1 illustrates a Differential Scanning calorimetry (DSC) scan of N-(2-Aminoethyl)-1,3-propanediamine, an exemplary triamine which may be used as Phase Change Material (PCMs) in alternative embodiments as provided herein.

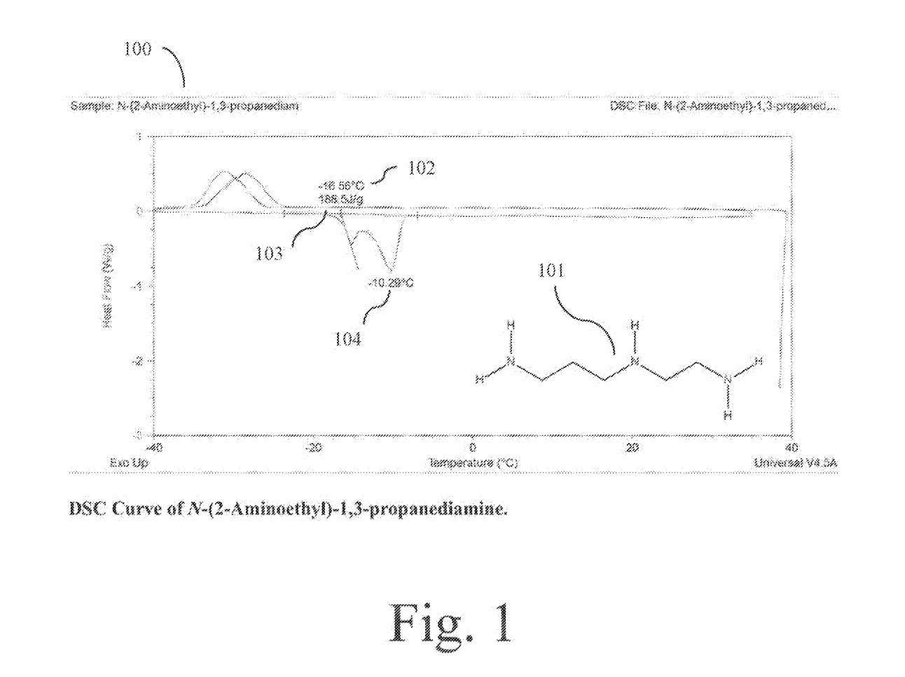

FIG. 2 illustrates a DSC scan of Spermidine, which may be used as Phase Change Material (PCMs) in alternative embodiments as provided herein.

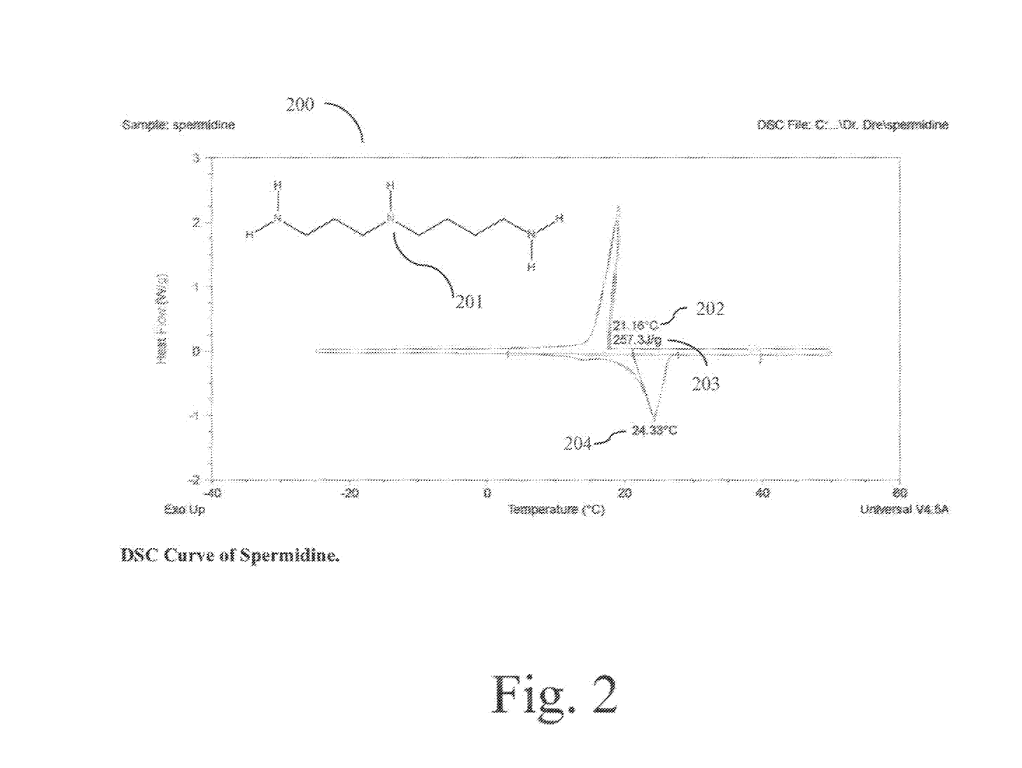

FIG. 3 illustrates a DSC scan of Bis(hexamethylene)triamine which may be used as Phase Change Material (PCMs) in alternative embodiments as provided herein.

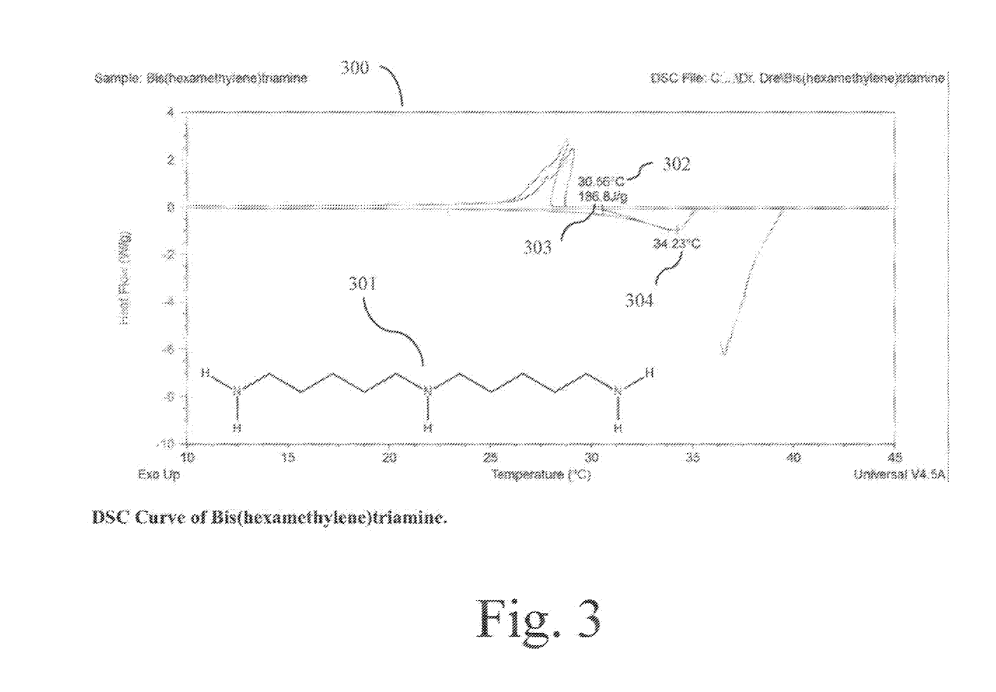

FIG. 4 illustrates a DSC scan of 3,3-diamnopropylamine which may be used as Phase Change Material (PCMs) in alternative embodiments as provided herein.

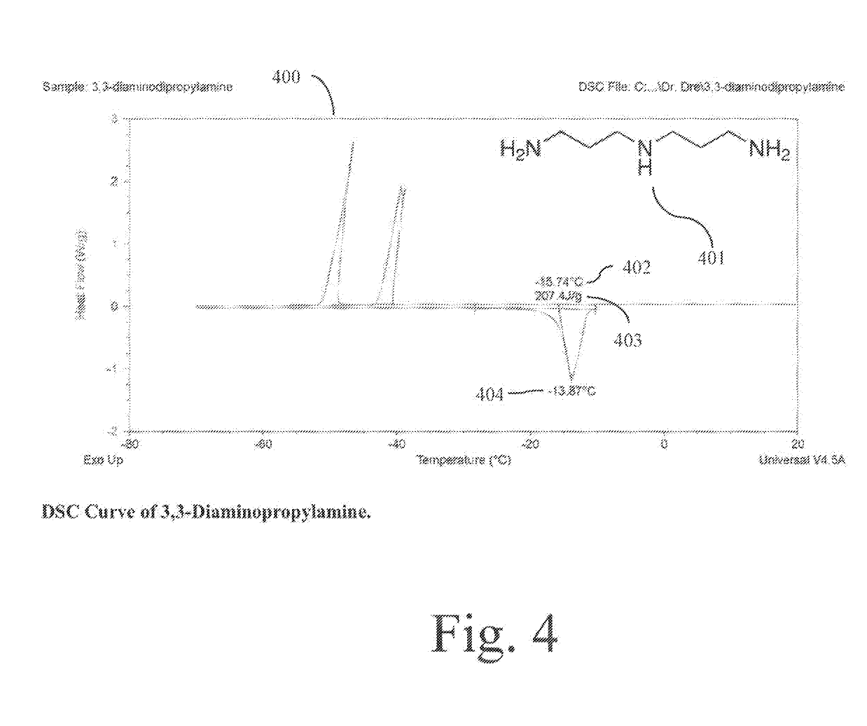

FIG. 5 illustrates a DSC scan of Tetradecanonitile which may be used as Phase Change Material (PCMs) in alternative embodiments as provided herein.

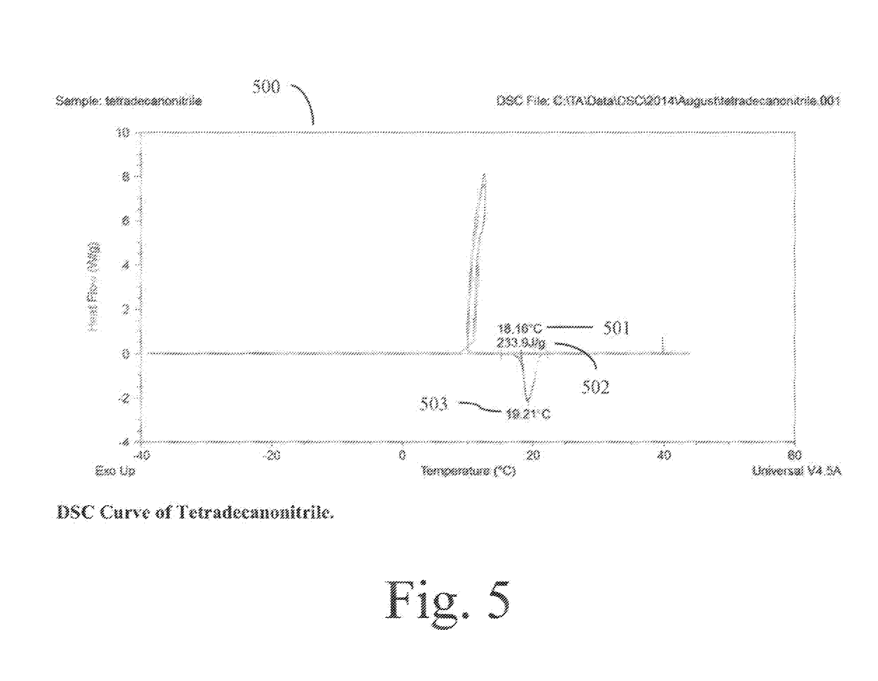

FIG. 6 illustrates a DSC scan of Heptadecanonitrile, which may be used as Phase Change Material (PCMs) in alternative embodiments as provided herein.

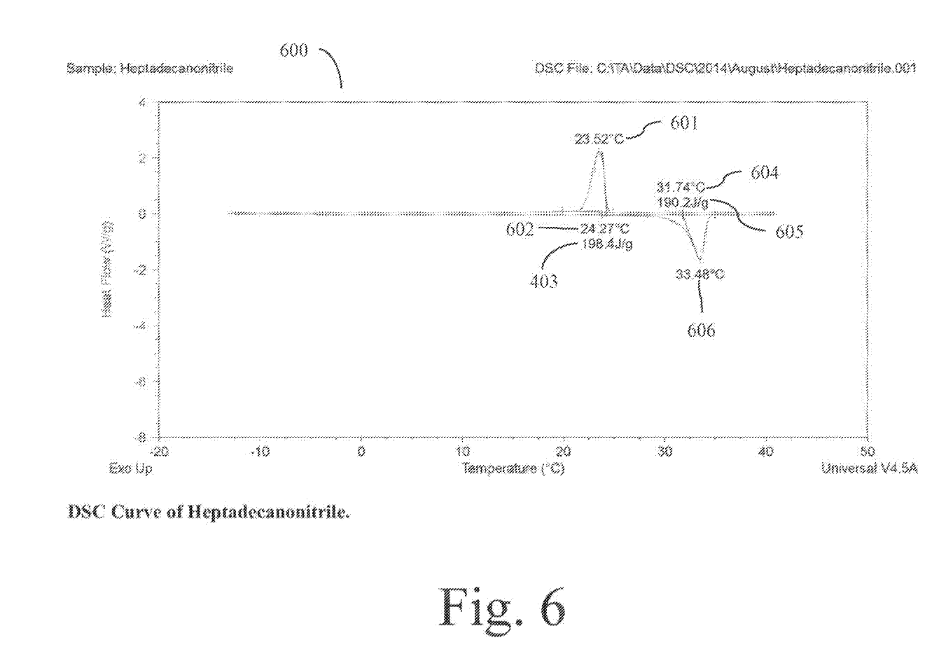

FIG. 7 illustrates a DSC scan of Nonadecanenitrile which may be used as Phase Change Material (PCMs) in alternative embodiments as provided herein.

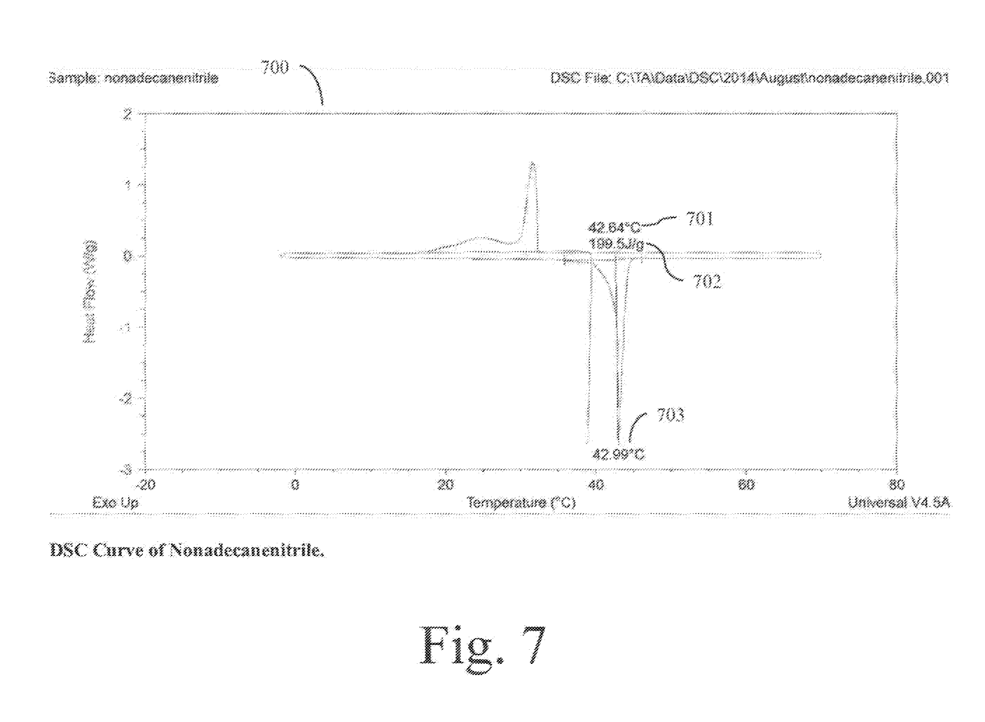

FIG. 8 illustrates a DSC scan of Dodecanenitrile which may be used as Phase Change Material (PCMs) in alternative embodiments as provided herein.

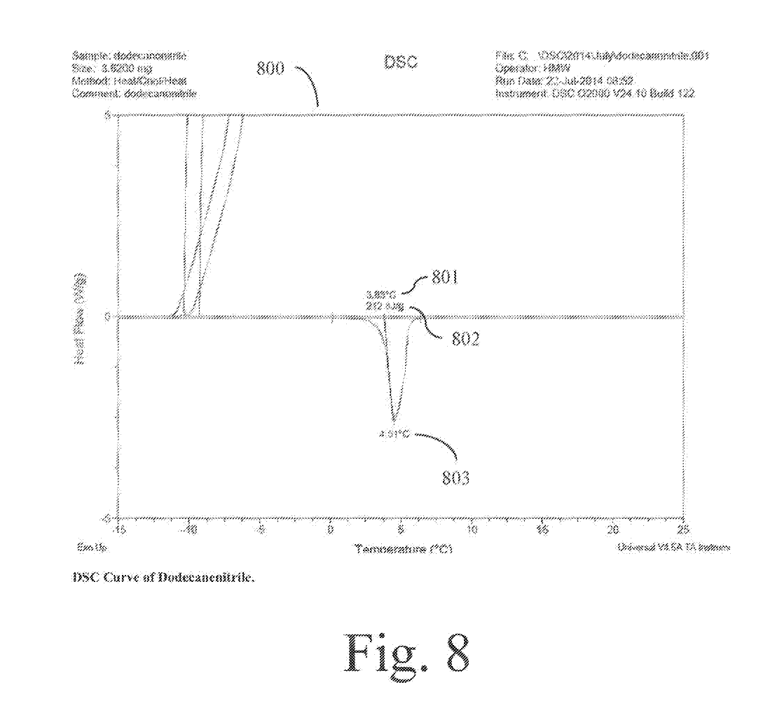

FIG. 9 illustrates a DSC scan of Octanoic Anhydride which may be used as Phase Change Material (PCMs) in alternative embodiments as provided herein.

FIG. 10 illustrates a DSC scan of Decanoic Anhydride, which may be used as Phase Change Material (PCMs) in alternative embodiments as provided herein.

FIG. 11 illustrates a DSC scan of Docosanoic Anhydride, which may be used as Phase Change Material (PCMs) in alternative embodiments as provided herein.

FIG. 12 illustrates a DSC scan of Anthranilic acid which may be used as Phase Change Material (PCMs) in alternative embodiments as provided herein.

FIG. 13 illustrates a DSC scan of 2-Sulfobenzoic acid, which may be used as Phase Change Material (PCMs) in alternative embodiments as provided herein.

FIG. 14 illustrates a DSC scan of 2,4-Dihydroxybenzoic acid, which may be used as Phase Change Material (PCMs) in alternative embodiments as provided herein.

Reference will now be made in detail to various exemplary embodiments as provided herein The following detailed description is provided to give the reader a better understanding of certain details of aspects and embodiments as provided herein, and should not be interpreted as a limitation on the scope of the invention.

### DETAILED DESCRIPTION OF THE INVENTION

In alternative embodiments, provided are compounds used as Phase Change Material (PCMs) in thermal energy storage materials, temperature stabilization and/or thermal energy storage systems in accordance, and methods for making and using them. In alternative embodiments, provided are compositions, products of manufacture, and thermal energy storage (TES) or temperature stabilization compounds or systems, comprising: a Phase Change Material (PCM) compound selected from the group consisting of: a triamine; a nitrile; an anhydride; a benzoic acid; and a combination thereof; wherein optionally the PCM comprises: a triamine and a nitrile, a triamine and an anhydride, a triamine and a benzoic acid, a nitrile and an anhydride; a nitrile and a benzoic acid, an anhydride and a benzoic acid, wherein optionally the PCM comprises: a triamine; a nitrile; an anhydride; and a benzoic acid, wherein the phase change material compound is capable of undergoing a solid to liquid and a liquid to solid phase change transition.

### Triamines

In alternative embodiments, as provided herein are thermal energy storage materials comprising a phase change material (PCM) with favorable PCM characteristics including high latent heats, wherein the PCM undergoes solid to liquid and liquid to solid phase change transitions. Provided are thermal energy storage and temperature stabilization materials and products of manufacture, and exemplary applications include: building and insulation materials e.g., walls, flooring, ceiling and tank devices used to moderate climates in buildings, food and drug storage coolers or other types of coolers, containers, devices used to keep food, drugs or pharmaceutical cold or warm, and essentially any device used to keep a substance at a relatively constant temperature between about −35° C. and 50° C. Provided are PCM compounds comprising triamines, e.g. trialkyl amines with exemplary compounds having a latent heat of fusion in the range of between about 186 and 257 J/g.

In alternative embodiments, provided are a composition, a product of manufacture, or a thermal energy storage (TES) or temperature stabilization compound, comprising: a Phase Change Material (PCM) compound comprising a triamine, wherein the phase change material compound is capable of undergoing a solid to liquid and a liquid to solid phase change transition. In alternative embodiments, the triamine is selected from the group consisting of: an N-(2-Aminoethyl)-1,3-propanediamine, a spermidine, bis(hexamethylene)triamine, a 3,3-diamnopropylamine and a combination thereof.

In alternative embodiments, provided are a nanoparticle, a microparticle, a macroparticle, a liposome, a capsule, or a microcapsule comprising a phase change material-comprising composition as provided herein.

In alternative embodiments, provided are an article of manufacture, a product of manufacture, a coating, a liquid, a gel, an antifreeze fluid, a fluid, an ink, an oil, a lubricant, a sealant, a paint, a textile, a cloth, a clothing, an upholstered furniture, a matting, a bedding or bedding system, a pharmaceutical or drug delivery system, comprising: nanoparticle, a microparticle, a macroparticle, a liposome, a capsule, or a microcapsule, as provided herein, or, comprising a composition, product of manufacture, or thermal energy storage compound, or a phase change material-comprising composition as provided herein.

In alternative embodiments, provided are a building or an insulation material, an automotive material, a packaging material, a garment, a footwear or a footwear material, or an energy storage or temperature stabilization system, comprising: nanoparticle, a microparticle, a macroparticle, a liposome, a capsule, or a microcapsule, as provided herein, or, comprising a composition, product of manufacture, or thermal energy storage or temperature stabilization compound, or a phase change material-comprising composition as provided herein.

In alternative embodiments, provided are PCMs comprising triamines for use in thermal energy management and temperature stabilization. In alternative embodiments, triamines having desirable PCM characteristics, including in alternative embodiments very high latent heats, e.g., in the range of between about 186 to 257 J/g, are used. Because of the diversity and commercial availability of triamines, provided are a range of PCMs comprising triamines that can be economically produced, each with a unique melting point that can be tailored for a specific thermal energy management and/or temperature stabilization application.

In alternative embodiments, provided are organic phase change materials (PCMs) comprising triamines, e.g. trialkyl amines. In alternative embodiments, provided are thermal energy storage (TES) materials comprising a Phase Change Material (PCM) comprising a triamine, wherein the PCM capable is of undergoing a solid-to-liquid and liquid to-solid phase change. In alternative embodiments, during the solid-to-liquid phase change, the PCM absorbs or “stores” heat from its surrounding environment. In alternative embodiments, during the liquid-to-solid phase change, the PCM releases the absorbed or “stored” heat into its surrounding environment.

In alternative embodiments, provided are Phase Change Material (PCMs) compositions and products of manufacture comprising triamines, and methods for making and using them. In alternative embodiments, the Phase Change Material (PCMs) compositions are used for thermal energy management and/or temperature stabilization in various applications such as materials for making and using: building, insulation or construction materials; electronics and computers; automotive; airlines; boats; weapons systems; packaging materials or containers; pharmaceuticals; cloth, fabrics and, garments; and footwear, and other energy storage and temperature stabilization systems.

Any PCM comprising a triamine, or any triamine, can be used with the TES systems, compositions, products of manufacture, or systems as provided herein. In alternative embodiments, the PCM is comprised solely (i.e. 100%) of, or consists essentially of, the triamine. Exemplary triamines suitable for use in alternative embodiments as provided herein include, without limitation, trialkyl amines, such as diethylenetriamines, polyetheramines and the like. Exemplary trialkyl amines include trialkyl amines with an internal secondary amino group, as shown below:

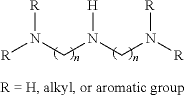

Other exemplary trialkyl amines include trialkyl amines with an internal tertiary amino group, as shown below:

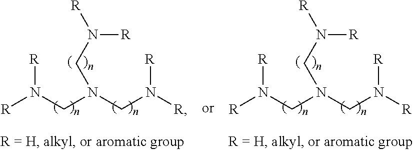

In alternative embodiments, exemplary PCMs are comprised of an aromatic triamine. Exemplary aromatic triamines include aromatic triamines with amine groups at C1, C3, and C5, as shown below:

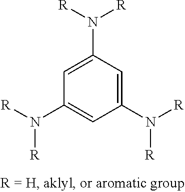

Other exemplary aromatic triamines include aromatic triamines with amine groups at C1, C2, and C5, as shown below:

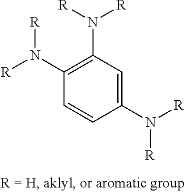

Still other exemplary aromatic triamines include aromatic triamines with amine groups at C1, C2, and C3, as shown below:

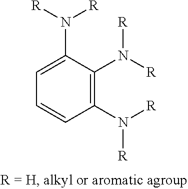

Other exemplary aromatic triamines include heterocyclic aromatic and nonaromatic molecules where one or more of the amine groups is part of the cyclic ring. For example pyridine aromatic triamines with other amine groups are that located on the C1, and C3, as shown below:

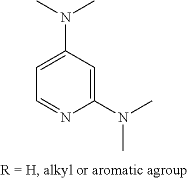

Other exemplary pyridine aromatic triamines with other amine groups that are located on the C1, and C2, as shown below:

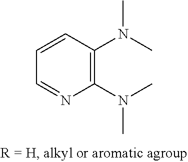

Other exemplary pyridine aromatic triamines with other amine groups that are located on the C1, and C4, as shown below:

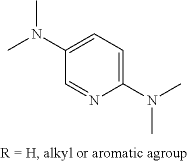

Other exemplary pyridine aromatic triamines with other amine groups that are located on the C1, and C5, as shown below:

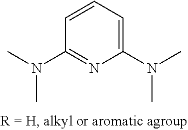

Other exemplary pyridine aromatic triamines with other amine groups are located on the C2, and C3, as shown below:

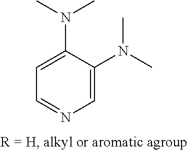

Other exemplary pyridine aromatic triamines with other amine groups are located on the C2, and C4, as shown below:

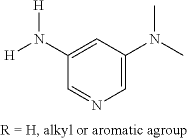

Other exemplary embodiments include polyetheramines characterized by repeating oxypropylene units in the backbone, e.g., trifunctional primary amines having amine groups located on secondary carbon atoms at the ends of aliphatic polyether chains:

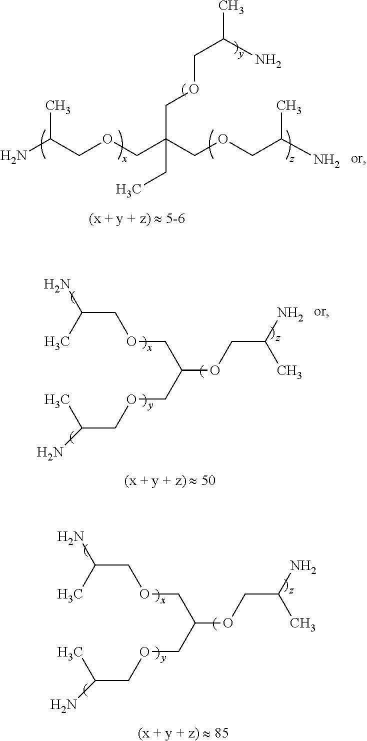

In alternative embodiments, provided are thermal energy storage and thermal stabilization systems comprising a PCM comprising a N-(2-aminoethyl)-1,3-propoanedimine, spermidine, bis(hexamethylene)triamine, and/or 3,3-diaminopropylamine.

In alternative embodiments, provided are thermal energy storage and thermal stabilization systems comprising a PCM comprising or consisting of: an N-(2-aminoethyl)-1,3-propoanedimine, a spermadine, a bis(hexamethylene)triamine, a 3,3-diaminopropylamine and a combination thereof.

Table 1 summarizes the PCM performance of various exemplary triamines. The latent heat (joules per gram (J/g)) and melting point (° C.) of these triamine are provided.

TABLE 1
Triamine thermal energy storage materials
and associated PCM characteristics

| Triamine | Melting Point (° C.) | Latent Heat (J/g) |
|---|---|---|
| N-(2-Aminoethyl)-1,3- | −10 | 189 |
| propoanedimine | | |
| Spermidine | 24 | 257 |
| Bis(hexamethylene)triamine | 34 | 187 |
| 3,3-Diaminopropylamine | −14 | 207 |

In alternative embodiments, the triamine PCM is obtained from a commercial vendor. In alternative embodiments, the triamines are manufactured or synthesized from starting ingredients. Trialkyl amines with amine groups of between 8 and 12 carbons are generally available commercially. Trialkyl amines with alkyl groups of 14 carbons or more are generally not available commercially.

In alternative embodiments, the TES systems comprise PCMs wherein the PCM comprises a trialkyl amine comprising an alkyl group of 10, 11, 12, 13, 14, 15, 16, 17, 18, 19, or 20 or more carbons, and optionally trialkyl amine are manufactured from starting ingredients, i.e. not purchased from a commercial vendor.

In alternative embodiments, n provided are products of manufacture, or compositions or articles, including e.g., pharmaceuticals, food storage, fabrics, clothing or any apparel such as shoes or gloves, industrial reaction containers, building materials, building superstructures, comprising one or a mixture of: (a) (i) a phase change material (PCM) composition comprising a triamine, wherein the triamine undergoes solid to liquid and liquid to solid phase change transitions, wherein optionally the triamine (or the at least one triamine) is at least about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM, (ii) a thermal energy storage composition, product of manufacture or system as provided herein, (iii) a thermal energy storage or temperature stabilization composition as provided herein; or (iv) any combination thereof; and (b) an insulation material, a conventional insulation material, product of manufacture, article or a composition.

In alternative embodiments, the building materials, products of manufacture, or compositions or articles comprise: a wall, a ceiling, a flooring, a window or window covering, a liquid (e.g., a liquid nitrogen or liquid oxygen), a gasoline or natural gas, a diesel, a gas (e.g., a fluorinated aliphatic organic compound gas such as FREON™, a helium, a nitrogen), an oil, or a fuel, or a transport or a storage device or container, or a tank device; or a weapons system or a missile.

In alternative embodiments, provided are food or textile storage materials or containers, body armor, helmets, devices, refrigerators, coolers, shipping containers, or containers; or textiles, comprising: (a) a phase change material (PCM) composition comprising a triamine, wherein the triamine undergoes solid to liquid and liquid to solid phase change transitions, wherein optionally the triamine is at least about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM, (b) a thermal energy storage or temperature stabilization composition, product of manufacture or system as provided herein, (c) a thermal energy storage or temperature stabilization composition as provided herein; or (d) any combination thereof.

In alternative embodiments, provided is an auto or an automotive part, a truck, a train, an airplane, or a ship body, a superstructure, a material, part or frame comprising: (a) a phase change material (PCM) composition comprising a triamine, wherein optionally the triamine undergoes solid to liquid and liquid to solid phase change transitions, wherein optionally the triamine is at least about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM, (b) a thermal energy storage or temperature stabilization composition, product of manufacture or system as provided herein, (c) a thermal energy storage or temperature stabilization composition as provided herein; or (d) any combination thereof.

In alternative embodiments, provided are medical devices, prostheses, or implants comprising: (a) a phase change material (PCM) composition comprising a triamine, wherein the triamine undergoes solid to liquid and liquid to solid phase change transitions, wherein optionally the triamine is at least about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM, (b) a thermal energy storage or temperature stabilization product of manufacture or system as provided herein, (c) a thermal energy storage or temperature stabilization composition as provided herein; or (d) any combination thereof.

In alternative embodiments, provided cooler devices (i.e. a thermal energy storage or temperature stabilization system) comprising a PCM, wherein the PCM is a triamine, suitable for storing and/or transporting life science materials. In alternative embodiments, an ideal temperature range for storing and transporting life science materials is between about 2° C. and 23° C. Accordingly, for these embodiments, the triamine selected for use in the TES used for storing and/or transporting life science materials has a melting and crystallization temperature of between about 2° C. and 23° C.

In alternative embodiments, provided are a thermal energy storage or temperature stabilization system comprising a PCM, wherein the PCM is a triamine, and wherein the TES is integrated into building, insulation or construction materials, e.g., floor, ceiling or wall boards. In alternative embodiments, the ideal temperature range for the interior of building is about 23° C. and 26° C. Accordingly, for these embodiments, the triamine selected for use in the TES used in the building, insulation or construction material has a melting and crystallization temperature of between about 23° C. and 26° C., e.g. spermidine.

In alternative embodiments, provided are thermal energy storage or temperature stabilization systems comprising a PCM, wherein the PCM is a triamine, and wherein the TES is integrated into bedding or upholstered materials, or a polyol (e.g., a polyether polyol) manufacturing, e.g. a mattress, upholstery (e.g., upholstered furniture), pillows, matts. The ideal temperature range for the interior of a mattress, bedding or upholstered product is about 23° C. and 28° C. Accordingly, the triamine selected for use in the TES used in the bedding material has a melting and crystallization temperature of between about 23° C. and 26° C., e.g., spermidine.

In alternative embodiments, provided are thermal energy storage or temperature stabilization materials comprising an encapsulated triamine PCM. In alternative embodiments triamine PCMs can be encapsulated by any known method generally known in the art. The encapsulated PCMs can be microencapsulated, i.e. generally contained capsules of less than 1 mm in diameter, or they can be macroencapsulated, i.e. generally contained in capsules of greater than 1 mm in diameter.

In alternative embodiments, provided are thermal energy storage or temperature stabilization materials comprising a heterogeneous mixture of the triamine PCM material, and one or more additional materials, e.g. a building material comprising a mixture of the triamine PCM material and a conventional insulating material such as a fiberglass. In other embodiments, the triamine PCM thermal storage or temperature stabilization materials can be homogeneous, meaning that they are not incorporated into a mixture of materials, e.g. as a thermal energy or temperature stabilization layer comprised of triamine within a package used to transport food, drinks, biological agents or reagents, pharmaceuticals, drugs the like. In certain embodiments, the triamine PCM thermal storage materials can be incorporated into existing thermal energy or temperature stabilization management systems, e.g. building insulation, coolers, containers, industrial thermal storage tanks, residential heating systems, or the like.

### Nitriles

In alternative embodiments, provided herein are thermal energy storage and temperature stabilization materials comprising a phase change material (PCM) with favorable PCM characteristics including high latent heats, wherein the thermal energy storage material undergoes solid to liquid and liquid to solid phase change transitions. Provided are thermal energy storage and temperature stabilization materials and products of manufacture, and exemplary applications include: building and insulation materials e.g. walls, flooring, ceiling and tank devices used to moderate climates in buildings, food and drug storage coolers, containers, or other types of coolers, devices used to keep food, drugs or pharmaceutical cold or warm, and any device used to keep a substance at a relatively constant temperature between about −80° C. and 60° C. Also provided are PCM compounds and products of manufacture comprising nitriles, e.g. alkyl nitriles, with exemplary compounds having a latent heat of fusion in the range of between about 190 and 233 J/g.

Provided are a composition, a product of manufacture, or a thermal energy storage (TES) or temperature stabilization compound or system, comprising: a Phase Change Material (PCM) compound comprising a nitrile, wherein the phase change material compound is capable of undergoing a solid to liquid and a liquid to solid phase change transition. In alternative embodiments, the nitrile can be selected from the group consisting of: mononitriles, dinitriles, trinitriles, polynitriles and a combination thereof; or, the nitrile is, or comprises, an alkyl nitrile; or, the nitrile is, or comprises, an aromatic nitrile; or, the nitrile is selected from the group consisting of: tetradecanonitrile, heptadecanonitrile, nonadecanenitrile, dodecanenitrile and a combination thereof.

In alternative embodiments, the nitrile is synthesized via a Kolbe nitrile synthesis method, the CSI method, or the ammonia.

Provided are a nanoparticle, a microparticle, a macroparticle, a liposome, a capsule, or a microcapsule, comprising a phase change material-comprising composition as provided herein.

Provided are an article of manufacture, a product of manufacture, a coating, a liquid, a gel, an antifreeze fluid, a fluid, an ink, an oil, a lubricant, a sealant, a paint, a textile, a cloth, a clothing, an upholstered furniture, a matting, a bedding or bedding system, a pharmaceutical or drug delivery system, comprising: nanoparticle, a microparticle, a macroparticle, a liposome, a capsule, or a microcapsule, as provided herein, or, comprising a composition, product of manufacture, or thermal energy storage compound, or a phase change material-comprising composition as provided herein.

Provided are a building or an insulation material, an automotive material, a packaging material, a garment, a footwear or a footwear material, or an energy storage or temperature stabilization system, comprising: a nanoparticle, a microparticle, a macroparticle, a liposome, a capsule, or a microcapsule, as provided herein, or, comprising a composition, product of manufacture, or thermal energy storage compound, or a phase change material-comprising composition as provided herein.

In alternative embodiments, provided are PCMs comprising nitriles for use in thermal energy management and temperature stabilization. In alternative embodiments, nitriles having desirable PCM characteristics including, in alternative embodiments, very high latent heats, e.g., in the range of between about 190 to 233 J/g are used. Because of the diversity and commercial availability of nitriles, provided are a range of PCMs comprising nitriles that can be economically produced, each with a unique melting point that can be tailored for a specific thermal energy management and/or temperature stabilization application. In alternative embodiments, the nitrile is a mononitrile a dinitrile, a trinitrile, an alkyl nitrile, an aromatic nitrile or a combination thereof.

In alternative embodiments, provided are organic phase change materials (PCMs), and products of manufacture comprising them, comprising one or more nitriles or any organic compound that has a —C≡N functional group, e.g. alkyl nitriles, dinitriles, trinitriles, alkyl nitriles, aromatic nitriles, a polynitrile (e.g., an ethylenetetracarbonitrile) or a combination thereof.

In alternative embodiments, provided are thermal energy storage (TES) and temperature stabilization materials comprising a Phase Change Material (PCM) comprising a nitrile, wherein the PCM capable is of undergoing a solid-to-liquid and liquid to-solid phase change. In alternative embodiments, during the solid-to-liquid phase change, the PCM absorbs or “stores” latent heat from its surrounding environment. In alternative embodiments, during the liquid-to-solid phase change, the PCM releases the absorbed or “stored” energy into its surrounding environment.

In alternative embodiments, provided are Phase Change Material (PCMs) compositions and products of manufacture comprising nitriles, and methods for making and using them. In alternative embodiments, the Phase Change Material (PCMs) compositions and products of manufacture are used for thermal energy management and temperature stabilization in various applications such as materials for making or using: building, insulation or construction materials; electronics and computers, weapons systems; automotives; airlines; boats; packaging materials or containers; pharmaceuticals; cloth, fabrics and garments; and footwear, and other energy storage and temperature stabilization systems.

Any PCM comprising a nitrile, or any nitrile, can be used with the TES systems, compositions, products of manufacture, or systems as provided herein. Exemplary alkyl nitriles suitable for use in alternative embodiments as provided herein include, without limitation, ethylenetetracarbonitrile, tetradecanonitrile, heptadecanonitrile, nonadecanenitrile, and dodecanenitrile.

In alternative embodiments, a thermal energy storage or temperature stabilization system or product of manufacture comprising a PCM is provided wherein the PCM comprises a tetradecanonitrile, a heptadecanonitrile, a nonadecanenitrile, a dodecanenitrile, or any combination thereof.

Table 2 summarizes the PCM performance of various alkyl nitriles. The latent heat (joules per gram (J/g)) and melting point (° C.) of these nitriles are provided.

TABLE 2
Nitrile thermal energy storage and temperature stabilization
materials and associated PCM characteristics

| Nitrile | Melting Point (° C.) | Latent Heat (J/g) |
|---|---|---|
| Tetradecanonitrile | 19 | 234 |
| Heptadecanonitrile | 33 | 190 |
| Nonadecanenitrile | 43 | 200 |
| Dodecanenitrile | 5 | 213 |

In certain embodiments, the nitrile selected for use as the PCM is a commercially available nitrile. In other embodiments, provided are methods for synthesizing nitriles for use as a PCM in a TES system. In alternative embodiments, synthetic methods are utilized to synthesize even- and odd-chain nitriles via the Kolbe nitrile synthesis method (reaction of primary aliphatic halides and alkali metal cyanides). In various exemplary embodiments, the Kolbe nitrile synthesis method is utilized to generate alkyl nitriles with favorable PCM characteristics wherein an alkyl halide, e.g. an alkyl halide selected from the group consisting of a chloride, a bromide, or an iodide, is reacted with potassium or sodium cyanide in a high boiling solvent (dimethyl sulfoxide, DMSO) at elevated temperatures. The following reaction scheme shows the Kolbe nitrile synthesis method used to generate odd chain alkyl nitriles (the method is not limited to the synthesis of odd chain alkyl nitriles):

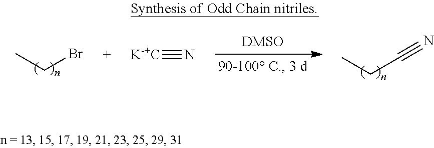

In alternative embodiments, other synthetic routes are used to generate nitriles for use as PCMs. In various exemplary embodiments, a fatty acid is reacted with chlorosulfonyl isocyanate (CSI) and N,N-dimethylformamide (DMF) using dichloromethane (DCM) as a solvent. The foregoing synthetic pathway is referred to herein as the “CSI” method. The following exemplary reaction scheme shows the CSI method used to generate even chain alkyl nitriles (the method is not limited to the synthesis of even chain alkyl nitriles), see also Mekki-Berrada, A., et al (2013) Ammoniation—Dehydration of Fatty Acids into Nitriles: Heterogeneous or Homogeneous Catalysis?. ChemSusChem, 6: p. 1478-1489, for additional exemplary reaction schemes:

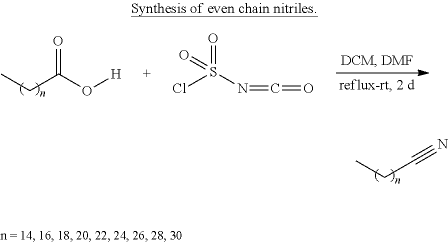

In alternative embodiments, provided are products of manufacture, or compositions or articles, including e.g., pharmaceuticals, food storage, fabrics, clothing or any apparel such as shoes or gloves, industrial reaction containers building materials, building superstructures, or insulation material for any use, such as e.g., buildings, vehicles, containers, vats, and the like, comprising one or a mixture of: (a) (i) a phase change material (PCM) composition comprising a nitrile, wherein the nitrile undergoes solid to liquid and liquid to solid phase change transitions, wherein optionally the nitrile (or the at least one nitrile) is at least about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM, (ii) a thermal energy storage or temperature stabilization product of manufacture or system as provided herein, (iii) a thermal energy storage or temperature stabilization composition as provided herein; or (iv) any combination thereof; and (b) an insulation material, a conventional insulation material, product of manufacture, article or a composition.

In alternative embodiments, the building materials, products of manufacture, or compositions or articles comprise: a wall, a ceiling, a flooring, a window or window covering, a liquid (e.g., a liquid nitrogen or liquid oxygen), a gasoline or natural gas, a diesel, a gas (e.g., a fluorinated aliphatic organic compound gas such as FREON™, a helium, a nitrogen), an oil, or a fuel, or a transport or a storage device or container, or a tank device; or a weapons system or a missile.

In alternative embodiments, provided are food or textile storage materials or containers, body armor, helmets, devices, refrigerators, coolers, shipping containers, or containers; or textiles, comprising: (a) a phase change material (PCM) composition comprising a nitrile, wherein the nitrile undergoes solid to liquid and liquid to solid phase change transitions, wherein optionally the nitrile is at least about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM, (b) a thermal energy storage or temperature stabilization composition, product of manufacture or system as provided herein, (c) a thermal energy storage or temperature stabilization composition as provided herein; or (d) any combination thereof.

In alternative embodiments, provided is an auto or an automotive part, a truck, a train, an airplane, or a ship body, a superstructure, a material, part or frame comprising: (a) a phase change material (PCM) composition comprising a nitrile, wherein optionally the nitrile undergoes solid to liquid and liquid to solid phase change transitions, wherein optionally the nitrile is at least about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM, (b) a thermal energy storage or temperature stabilization product of manufacture or system as provided herein, (c) a thermal energy storage or temperature stabilization composition as provided herein; or (d) any combination thereof.

In alternative embodiments, provided are medical devices, prostheses, or implants comprising: (a) a phase change material (PCM) composition comprising a nitrile, wherein the nitrile undergoes solid to liquid and liquid to solid phase change transitions, wherein optionally the nitrile is at least about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM, (b) a thermal energy storage or temperature stabilization product of manufacture or system as provided herein, (c) a thermal energy storage or temperature stabilization composition as provided herein; or (d) any combination thereof.

In alternative embodiments, provided cooler devices (i.e. a thermal energy storage or temperature stabilization system) comprising a PCM, wherein the PCM is a nitrile, suitable for storing and/or transporting life science materials. In alternative embodiments, an ideal temperature range for storing and transporting life science materials is between about 2° C. and 23° C. Accordingly, for these embodiments, the nitrile selected for use in the TES used for storing and/or transporting life science materials has a melting and crystallization temperature of between about 2° C. and 23° C.

In alternative embodiments, provided are a thermal energy storage system or temperature stabilization comprising a PCM, wherein the PCM is a nitrile, and wherein the TES is integrated into building, insulation or construction materials, e.g., floor, ceiling or wall boards. In alternative embodiments, the ideal temperature range for the interior of building is about 23° C. and 26° C. Accordingly, for these embodiments, the nitrile selected for use in the TES used in the building, insulation or construction material has a melting and crystallization temperature of between about 23° C. and 26° C.

In alternative embodiments, provided are thermal energy storage or temperature stabilization systems comprising a PCM, wherein the PCM is a nitrile, and wherein the TES is integrated into bedding or upholstered materials, or a polyol (e.g., a polyether polyol) manufacturing, e.g. a mattress, upholstery (e.g., upholstered furniture), pillows, matts. The ideal temperature range for the interior of a mattress, bedding or upholstered product is about 23° C. and 28° C. Accordingly, the nitrile selected for use in the TES used in the bedding material has a melting and crystallization temperature of between about 23° C. and 26° C.

In alternative embodiments, provided are thermal energy or temperature stabilization storage materials comprising an encapsulated nitrile PCM. In alternative embodiments nitrile PCMs are encapsulated by any known method generally known in the art. The encapsulated PCMs can be microencapsulated, i.e. generally contained capsules of less than 1 mm in diameter, or they can be macroencapsulated, i.e. generally contained in capsules of greater than 1 mm in diameter.

In alternative embodiments, provided are thermal energy storage or temperature stabilization materials comprising a heterogeneous mixture of the nitrile PCM material, and one or more additional materials, e.g. a building material comprising a mixture of the nitrile PCM material and a conventional insulating material such as fiberglass. In other embodiments, the nitrile PCM thermal storage or temperature stabilization materials can be homogeneous, meaning that they are not incorporated into a mixture of materials, e.g. as a thermal energy layer comprised of nitrile within a package used to transport food, drinks, biological agents or reagents, pharmaceuticals, drugs and the like. In certain embodiments, the nitrile PCM thermal storage or temperature stabilization materials can be incorporated into existing thermal energy or temperature stabilization management systems, e.g. building insulation, coolers, containers, industrial thermals storage tanks, residential heating systems, or the like.

### Anhydrides

In alternative embodiments, provided are thermal energy storage and temperature stabilization materials comprising a phase change material (PCM) with favorable PCM characteristics including high latent heats, wherein the thermal energy storage material undergoes solid to liquid and liquid to solid phase change transitions. Provided are thermal energy storage and temperature stabilization materials and products of manufacture, and exemplary applications include: building and insulation materials e.g. walls, flooring, ceiling and tank devices used to moderate climates in buildings, food and drug storage coolers, containers, or other types of coolers, devices used to keep food, drugs or pharmaceutical cold or warm, and any device used to keep a substance at a relatively constant temperature between about −80° C. and 115° C. Also provided are PCM compounds and products of manufacture comprising anhydrides, e.g. alkyl anhydrides, with exemplary compounds having a latent heat of fusion in the range of between about 190 and 233 J/g.

Provided are a composition, a product of manufacture, or a thermal energy storage (TES) or temperature stabilization compound or system, comprising: a Phase Change Material (PCM) compound comprising an anhydride, wherein the phase change material compound is capable of undergoing a solid to liquid and a liquid to solid phase change transition. In alternative embodiments, the anhydride can be organic acid anhydrides, alkyl anhydrides and/or aryl anhydrides, including e.g., octanoic anhydrides, decanoic anhydrides, and docosanoic anhydrides.

Provided are a nanoparticle, a microparticle, a macroparticle, a liposome, a capsule, or a microcapsule comprising a phase change material-comprising composition as provided herein.

Provided are an article of manufacture, a product of manufacture, a coating, a liquid, a gel, an antifreeze fluid, a fluid, an ink, an oil, a lubricant, a sealant, a paint, a textile, a cloth, a clothing, an upholstered furniture, a matting, a bedding or bedding system, a pharmaceutical or drug delivery system, comprising: a nanoparticle, a microparticle, a macroparticle, a liposome, a capsule, or a microcapsule as provided herein, or, comprising a composition, product of manufacture, or thermal energy storage compound, or a phase change material-comprising composition as provided herein.

Provided are a building or an insulation material, an automotive material, a packaging material, a garment, a footwear or a footwear material, or an energy storage or temperature stabilization system, comprising: a nanoparticle, a microparticle, a macroparticle, a liposome, a capsule, or a microcapsule as provided herein, or, comprising a composition, product of manufacture, or thermal energy storage compound, or a phase change material-comprising composition as provided herein.

In alternative embodiments, provided are PCMs comprising anhydrides for use in thermal energy management and temperature stabilization. In alternative embodiments, anhydrides having desirable PCM characteristics including very high latent heats, e.g., in the range of between about 150 to 216 J/g are used. Because of the diversity and commercial availability of anhydrides, provided are a range of PCMs comprising anhydrides that can be economically produced, each with a unique melting point that can be tailored for a specific thermal energy management and/or temperature stabilization application.

In alternative embodiments, the anhydride PCM is an organic acid anhydride, including symmetrical or unsymmetrical (mixed) anhydrides, e.g. a carboxylic acid anhydride (symmetrical), or an acetic-formic anhydride (mixed). In alternative embodiments, the anhydride PCM is an alkyl anhydride, for example, where R¹ and R² are independently the same or a different alkyl or aryl group of groups:

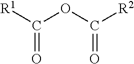

In alternative embodiments, the alkyl anhydride PCM comprises two aliphatic chains as shown below, where ‘n’ can be between 0 to 28.

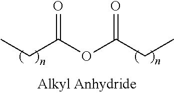

In alternative embodiments, the anhydride PCM can be an aryl anhydride, as shown below, where the ‘R’ groups can be independently a hydrogen or some other functional group, e.g. an alkyl group, an aryl group, an amino group, a hydroxyl group, a halide, or any another functional group.

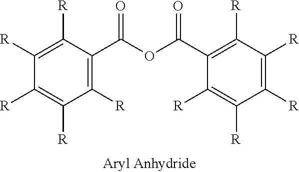

In alternative embodiments, provided are organic phase change materials (PCMs), and products of manufacture comprising them, comprising an anhydride.

In alternative embodiments, provided are thermal energy storage (TES) and temperature stabilization materials comprising a Phase Change Material (PCM) comprising an anhydride, wherein the PCM capable is of undergoing a solid-to-liquid and liquid to-solid phase change. In alternative embodiments, during the solid-to-liquid phase change, the PCM absorbs or “stores” latent heat from its surrounding environment. In alternative embodiments, during the liquid-to-solid phase change, the PCM releases the absorbed or “stored” energy into its surrounding environment.

In alternative embodiments, provided are Phase Change Material (PCMs) compositions and products of manufacture comprising anhydrides, and methods for making and using them. In alternative embodiments, the Phase Change Material (PCMs) compositions and products of manufacture are used for thermal energy management and temperature stabilization in various applications such as materials for making or using: building, insulation or construction materials; electronics and computers, automotives; airlines; boats; weapons systems; packaging materials or containers; pharmaceuticals; cloth, fabrics and garments; and footwear, and other energy storage and temperature stabilization systems.

Any PCM comprising an anhydride, or any anhydride, can be used with a TES system, composition, product of manufacture, or system as provided herein. Exemplary anhydrides suitable for use in alternative embodiments as provided herein include, without limitation, an alkyl anhydride e.g. acetic anhydride, hexanoic anhydride, octanoic anhydride, decanoic anhydride, dodecanoic anhydride, octadecanoic anhydride, cosanoic anhydride, docosanoic anhydride, hexacosanoic anhydride, or tricosanioc anhydride.

Other exemplary anhydrides suitable for use in alternative embodiments as provided herein include, without limitation, aryl (benzoic) anhydrides e.g. benzoic anhydride, 4-nitrobenzoic anhydride, perfluorobenzoic anhydride, 4-chlorobenzoic anhydride, 3-chlorobenzoic anhydride, 2-chlorobenzoic anhydride, 4-methoxybenzoic anhydride, 3,4-dimethoxybenzoic anhydride, 3,4,5-trimethoxybenzoic anhydride, 2,6-dichlorobenzoic anhydride, 3,5-dichlorobenzoic anhydride, 2-methylbenzoic anhydride, 3-methylbenzoic anhydride, 4-methylbenzoic anhydride, 4-aminobenzoic anhydride, 4-dimethylaminobenzoic anhydride, 3-dimethylaminobenzoic anhydride, 4-fluorobenzoic anhydride, 2-fluorobenzoic anhydride, 2-bromobenzoic anhydride, 4-bromobenzoic anhydride, 3-trifluoromethylbenzoic anhydride, 4-trifluoromethylbenzoic anhydride, 2-methyl-6-nitrobenzoic anhydride, and 2-amino-6-methylbenzoic anhydride.

In alternative embodiments, a thermal energy storage or temperature stabilization system or product of manufacture comprising a PCM is provided wherein the PCM comprises an acetic anhydride, hexanoic anhydride, octanoic anhydride, decanoic anhydride, dodecanoic anhydride, octadecanoic anhydride, cosanoic anhydride, docosanoic anhydride, hexacosanoic anhydride, tricosanioc anhydride, benzoic anhydride, 4-nitrobenzoic anhydride, perfluorobenzoic anhydride, 4-chlorobenzoic anhydride, 3-chlorobenzoic anhydride, 2-chlorobenzoic anhydride, 4-methoxybenzoic anhydride, 3,4-dimethoxybenzoic anhydride, 3,4,5-trimethoxybenzoic anhydride, 2,6-dichlorobenzoic anhydride, 3,5-dichlorobenzoic anhydride, 2-methylbenzoic anhydride, 3-methylbenzoic anhydride, 4-methylbenzoic anhydride, 4-aminobenzoic anhydride, 4-dimethylaminobenzoic anhydride, 3-dimethylaminobenzoic anhydride, 4-fluorobenzoic anhydride, 2-fluorobenzoic anhydride, 2-bromobenzoic anhydride, 4-bromobenzoic anhydride, 3-trifluoromethylbenzoic anhydride, 4-trifluoromethylbenzoic anhydride, 2-methyl-6-nitrobenzoic anhydride, and 2-amino-6-methylbenzoic anhydride or any combination thereof.

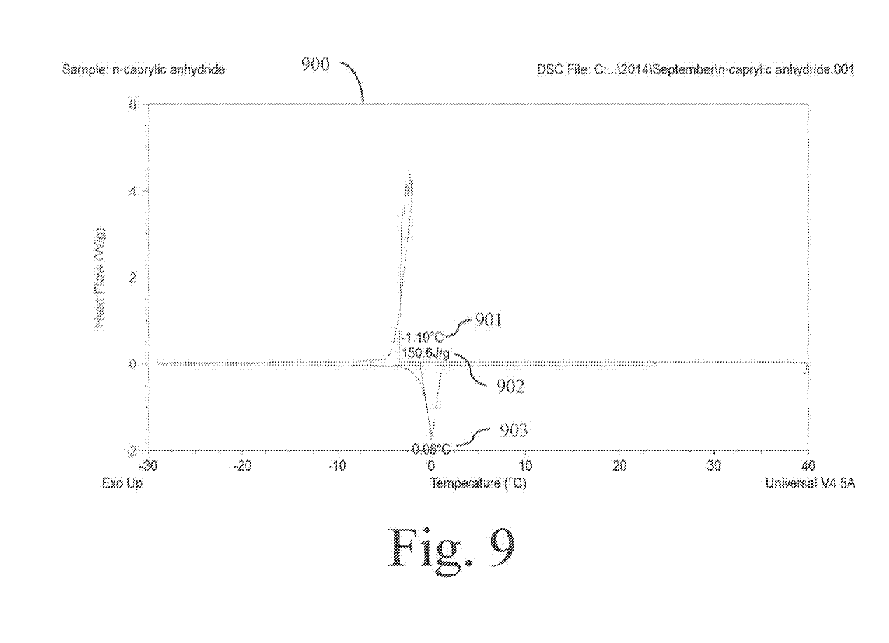

FIGS. 9 to 11 illustrate Differential Scanning calorimetry (DSC) scans of exemplary anhydrides that may be used for thermal energy storage and/or temperature stabilization in alternative embodiments as provided herein, and show freezing temperature, melting point and latent heat. DSC scans describe: a freezing temperature of the material, as shown by a first peak with an area above the x-axis; and, a melting temperature of the material, as shown by a second peak with an area under the x-axis. Temperature differences between freezing and melting point can be due to a number of factors including supercooling and instrument functionality e.g. differences in the scan rate when measuring freezing and melting. The latent heat of the scanned material is measured by calculating the area under the curve of each of the freezing and melting peaks.

FIG. 9 shows a DSC curve 900 of octanoic anhydride (i.e. n-caprylic anhydride) with a measured freezing temperature 901 of −1.10° C., a melting temperature 903 of 0.06° C. with a corresponding latent heat 902 of 150.6 J/g.

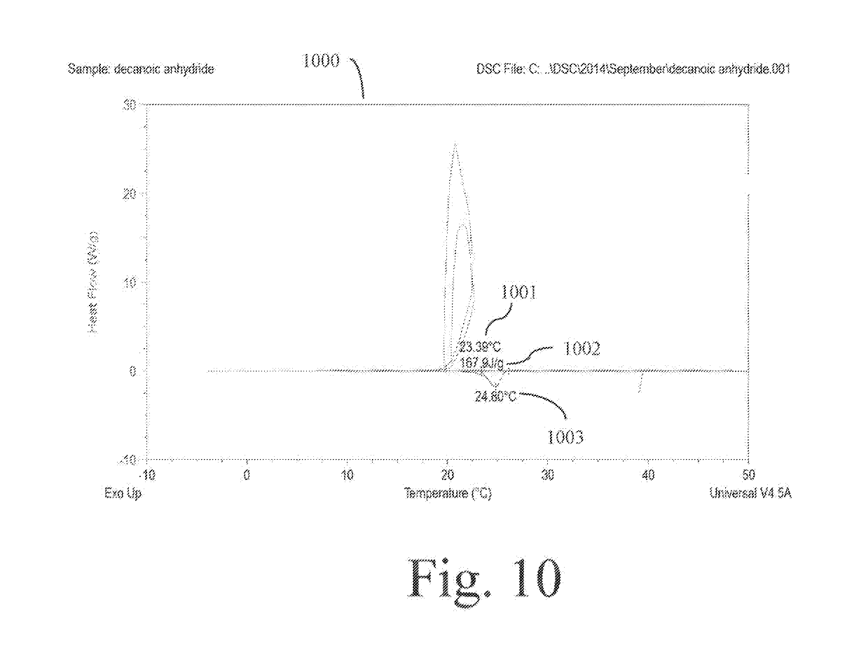

FIG. 10 shows a DSC curve 1000 of decanoic anhydride with a measured freezing temperature 1001 of 23.39° C., a melting temperature 1003 of 24.80° C. with a corresponding latent heat 1002 of 167.9 J/g.

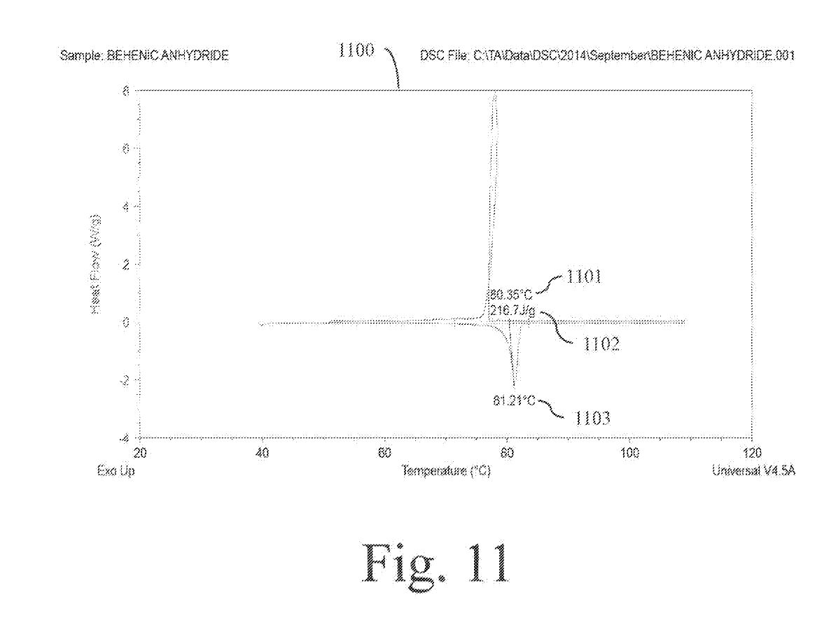

FIG. 11 shows a DSC curve 1100 of docosanoic anhydride (i.e. behenic anhydride) with a measured freezing temperature 1101 of 80.35° C., a melting temperature 1103 of 81.21° C. with a corresponding latent heat 1102 of 216.7 J/g corresponding latent heat 1102 of 216.7 J/g, and a melting temperature 1103 of 81.21° C.

Table 1 summarizes the PCM performance of various anhydrides as measured using Differential Scanning calorimetry. The latent heat (joules per gram (J/g)) and melting point (° C.) of these anhydrides are provided.

TABLE 3
Anhydride thermal energy storage and temperature stabilization
materials and associated PCM characteristics

| Anhydride | Melting Point (° C.) | Latent Heat (J/g) |
|---|---|---|
| Octanoic Anhydride | 0 | 151 |
| Decanoic Anhydride | 25 | 168 |
| Docosanoic Anhydride | 81 | 217 |

In certain embodiments, the anhydride selected for use as the PCM is a commercially available anhydride

In alternative embodiments, provided are products of manufacture, or compositions or articles, including e.g., pharmaceuticals, food storage, fabrics, clothing or any apparel such as shoes or gloves, industrial reaction containers building materials, building superstructures, or insulation material for any use, such as e.g., buildings, vehicles, containers, vats, and the like, comprising one or a mixture of: (a) (i) a phase change material (PCM) composition comprising an anhydride, wherein the anhydride undergoes solid to liquid and liquid to solid phase change transitions, wherein optionally the anhydride (or the at least one anhydride) is between about 30% and 100%, or at least about 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM, (ii) a thermal energy storage or temperature stabilization product of manufacture or system as provided herein, (iii) a thermal energy storage or temperature stabilization composition as provided herein; or (iv) any combination thereof; and (b) an insulation material, a conventional insulation material, product of manufacture, article or a composition.

In alternative embodiments, the building materials, products of manufacture, or compositions or articles comprise: a wall, a ceiling, a flooring, a window or window covering, a liquid (e.g., a liquid nitrogen or liquid oxygen), a gasoline or natural gas, a diesel, a gas (e.g., a fluorinated aliphatic organic compound gas such as FREON™, a helium, a nitrogen), an oil, or a fuel, or a transport or a storage device or container.

In alternative embodiments, provided are food or textile storage materials or containers, body armor, helmets, devices, refrigerators, coolers, shipping containers, or containers; or textiles, comprising: (a) a phase change material (PCM) composition comprising an anhydride, wherein the anhydride undergoes solid to liquid and liquid to solid phase change transitions, wherein optionally the anhydride is between about 30% and 100%, or at least about 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM, (b) a thermal energy storage or temperature stabilization composition, product of manufacture or system as provided herein, (c) a thermal energy storage or temperature stabilization composition as provided herein; or (d) any combination thereof.

In alternative embodiments, provided is an auto or an automotive part, a truck, a train, an airplane, or a ship body, a superstructure, a material, part or frame comprising: (a) a phase change material (PCM) composition comprising an anhydride, wherein optionally the anhydride undergoes solid to liquid and liquid to solid phase change transitions, wherein optionally the anhydride is between about 30% and 100%, or at least about 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM, (b) a thermal energy storage or temperature stabilization product of manufacture or system as provided herein, (c) a thermal energy storage or temperature stabilization composition as provided herein; or (d) any combination thereof.

In alternative embodiments, provided are medical devices, prostheses, or implants comprising: (a) a phase change material (PCM) composition comprising an anhydride, wherein the anhydride undergoes solid to liquid and liquid to solid phase change transitions, wherein optionally the anhydride is between about 30% and 100%, or at least about 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM, (b) a thermal energy storage or temperature stabilization product of manufacture or system as provided herein, (c) a thermal energy storage or temperature stabilization composition as provided herein; or (d) any combination thereof.

In alternative embodiments, provided cooler devices (i.e. a thermal energy storage or temperature stabilization system) comprising a PCM, wherein the PCM is an anhydride, suitable for storing and/or transporting life science materials. In alternative embodiments, an ideal temperature range for storing and transporting life science materials is between about 2° C. and 23° C. Accordingly, for these embodiments, an exemplary anhydride selected for use in the TES used for storing and/or transporting life science materials has a melting and crystallization temperature of between about 2° C. and 23° C.

In alternative embodiments, provided are a thermal energy storage system or temperature stabilization comprising a PCM, wherein the PCM is an anhydride, and wherein the TES is integrated into building, insulation or construction materials, e.g., floor, ceiling or wall boards. In alternative embodiments, the ideal temperature range for the interior of building is about 23° C. and 26° C. Accordingly, for these embodiments, an exemplary anhydride selected for use in the TES used in the building, insulation or construction material has a melting and crystallization temperature of between about 23° C. and 26° C.

In alternative embodiments, provided are thermal energy storage or temperature stabilization systems comprising a PCM, wherein the PCM is an anhydride, and wherein the TES is integrated into bedding or upholstered materials, or a polyol (e.g., a polyether polyol) manufacturing, e.g. a mattress, upholstery (e.g., upholstered furniture), pillows, matts. The ideal temperature range for the interior of a mattress, bedding or upholstered product is about 23° C. and 28° C. Accordingly, an exemplary anhydride selected for use in the TES used in the bedding material has a melting and crystallization temperature of between about 23° C. and 26° C. In alternative embodiments, provided are thermal energy or temperature stabilization storage materials comprising an encapsulated anhydride PCM. In alternative embodiments anhydride PCMs are encapsulated by any known method generally known in the art. The encapsulated PCMs can be microencapsulated, i.e. generally contained capsules of less than 1 mm in diameter, or they can be macroencapsulated, i.e. generally contained in capsules of greater than 1 mm in diameter.

In alternative embodiments, provided are thermal energy storage or temperature stabilization materials comprising a heterogeneous mixture of the anhydride PCM material, and one or more additional materials, e.g. a building material comprising a mixture of the anhydride PCM material and a conventional insulating material such as fiberglass. In other embodiments, the anhydride PCM thermal storage or temperature stabilization materials can be homogeneous, meaning that they are not incorporated into a mixture of materials, e.g. as a thermal energy layer comprised of anhydride within a package used to transport food, drinks, biological agents or reagents, pharmaceuticals, drugs and the like. In certain embodiments, the anhydride PCM thermal storage or temperature stabilization materials can be incorporated into existing thermal energy or temperature stabilization management systems, e.g. building insulation, coolers, containers, industrial thermals storage tanks, residential heating systems, or the like.

### Benzoic Acid

In alternative embodiments, provided are PCMs comprising a benzoic acid or a derivative thereof for use in thermal energy management and temperature stabilization. In alternative embodiments, benzoic acids having desirable PCM characteristics including, in alternative embodiments, very high latent heats, e.g., in the range of between about 137 to 753 J/g are used. In alternative embodiments, benzoic acids and derivatives thereof have high phase change transition temperatures due to the presence of an aromatic benzene ring. Benzoic acid and derivatives thereof have high latent heat whether the second substituent is located on the 2, 3, 4, 5, or 6^{th} positions on the benzene ring. Because of the diversity and commercial availability of benzoic acids, provided are a range of PCMs comprising benzoic acids and derivatives thereof that can be economically produced, each with a unique melting point that can be tailored for a specific thermal energy management and/or temperature stabilization application.

In alternative embodiments, provided are thermal energy storage (TES) and temperature stabilization materials comprising a Phase Change Material (PCM) comprising a benzoic acid, wherein the PCM capable is of undergoing a solid-to-liquid and liquid to-solid phase change. In alternative embodiments, during the solid-to-liquid phase change, the PCM absorbs or “stores” latent heat from its surrounding environment. In alternative embodiments, during the liquid-to-solid phase change, the PCM releases the absorbed or “stored” energy into its surrounding environment.

In alternative embodiments, provided are Phase Change Material (PCMs) compositions and products of manufacture comprising benzoic acids, and methods using them. In alternative embodiments, the Phase Change Material (PCMs) compositions and products of manufacture are used for thermal energy management and temperature stabilization in various applications such as materials for making or using: building, insulation or construction materials; electronics and computers, automotives; airlines; boats; weapons systems; packaging materials or containers; pharmaceuticals; cloth, fabrics and garments; and footwear, and other energy storage and temperature stabilization systems.

Any PCM comprising a benzoic acid, or any benzoic acid derivative, can be used with the TES systems, compositions, products of manufacture, or systems as provided herein. In alternative embodiments, the PCM is a benzoic acid as shown in the figure below, wherein the R functional group can be, for example, a carboxy, ester, amide, hydroxyl, halide, ether, alkyl, phenyl, amino, cyano, nitro, thiol or other functional groups. The benzene ring can be substituted with 2-6 similar or different substituents.

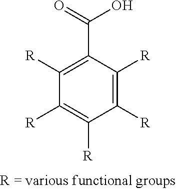

In alternative embodiments, the PCM is, e.g. 2-hydroxybenzoic acid, 3-hydroxybenzoic acid. 4-hydroxybenzoic acid, 4-amino-2-hydroxybenzoic acid, 5-amino-2-hydroxybenzoic acid, 3-amino-2-methoxybenzoic acid, 2-hydroxy-5-nitrobenzoic acid, 2-chloro-5-nitrobenzoic acid, 3,5-dinitro-2-hydroxybenzoic acid, 2-hydroxy-3-methylbenzoic acid, 2-hydroxy-5-nitrobenzoic acid, 4-cyanobenzoic acid, 2-acetoxybenzoic acid, 3-acetoxybenzoic acid, 3-methoxy-4-methylbenzoic acid, 4-dimethylaminobenzoic acid, 3-methoxybenzoic acid, 3,4-dimethoxybenzoic acid, 3,5-dimethylbenzoic acid, 1,2-benzenedicarboxylic acid, 1,2,4-benzenetricarboxylic acid, or 1,2,4,5-benzenetetracarboxylic acid.

Table 4 summarizes the PCM performance of various benzoic acids. The latent heat (joules per gram (J/g)) and melting point (° C.) of these nitriles are provided.

TABLE 4
Benzoic acid thermal energy storage and temperature stabilization
materials and associated PCM characteristics

| Nitrile | Melting Point (° C.) | Latent Heat (J/g) |
|---|---|---|
| Anthranilic acid | 143 | 157 |
| 2,4-dihydroxybenzoic acid | 202 | 753 |
| 2-sulfobenzoic acid | 113 | 138 |

In alternative embodiments, provided are products of manufacture, or compositions or articles, including e.g., pharmaceuticals, food storage, fabrics, clothing or any apparel such as shoes or gloves, industrial reaction containers building materials, building superstructures, or insulation material for any use, such as e.g., buildings, vehicles, containers, vats, and the like, comprising one or a mixture of: (a) (i) a phase change material (PCM) composition comprising a benzoic acid, wherein the benzoic acid undergoes solid to liquid and liquid to solid phase change transitions, wherein optionally the benzoic (or the at least one nitrile) is at least about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM, (ii) a thermal energy storage or temperature stabilization product of manufacture or system as provided herein, (iii) a thermal energy storage or temperature stabilization composition as provided herein; or (iv) any combination thereof; and (b) an insulation material, a conventional insulation material, product of manufacture, article or a composition.

In alternative embodiments, the building materials, products of manufacture, or compositions or articles comprise: a wall, a ceiling, a flooring, a window or window covering, a liquid (e.g., a liquid nitrogen or liquid oxygen), a gasoline or natural gas, a diesel, a gas (e.g., a fluorinated aliphatic organic compound gas such as FREON™, a helium, a nitrogen), an oil, or a fuel, or a transport or a storage device or container.

In alternative embodiments, provided are food or textile storage materials or containers, body armor, helmets, devices, refrigerators, coolers, shipping containers, cookware, solar energy panels, or containers; or textiles, comprising: (a) a phase change material (PCM) composition comprising a benzoic acid, wherein the benzoic acid undergoes solid to liquid and liquid to solid phase change transitions, wherein optionally the benzoic acid is at least about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM, (b) a thermal energy storage or temperature stabilization-composition, product of manufacture or system as provided herein, (c) a thermal energy storage or temperature stabilization composition as provided herein; or (d) any combination thereof.

In alternative embodiments, provided is an auto or an automotive part, a truck, a train, an airplane, or a ship body, a superstructure, a material, part or frame comprising: (a) a phase change material (PCM) composition comprising a benzoic acid, wherein optionally the benzoic acid undergoes solid to liquid and liquid to solid phase change transitions, wherein optionally the benzoic acid is at least about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM, (b) a thermal energy storage or temperature stabilization product of manufacture or system as provided herein, (c) a thermal energy storage or temperature stabilization composition as provided herein; or (d) any combination thereof.

In alternative embodiments, provided are medical devices, prostheses, or implants comprising: (a) a phase change material (PCM) composition comprising a benzoic acid, wherein the benzoic acid undergoes solid to liquid and liquid to solid phase change transitions, wherein optionally the benzoic acid is at least about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM, (b) a thermal energy storage or temperature stabilization product of manufacture or system as provided herein, (c) a thermal energy storage or temperature stabilization composition as provided herein; or (d) any combination thereof.

In alternative embodiments, provided are thermal energy or temperature stabilization storage materials comprising an encapsulated benzoic acid PCM. In alternative embodiments benzoic acids PCMs are encapsulated by any known method generally known in the art. The encapsulated PCMs can be microencapsulated, i.e. generally contained capsules of less than 1 mm in diameter, or they can be macroencapsulated, i.e. generally contained in capsules of greater than 1 mm in diameter.

In alternative embodiments, provided are thermal energy storage or temperature stabilization materials comprising a heterogeneous mixture of a benzoic acid PCM material, and one or more additional materials, e.g. a building material comprising a mixture of the benzoic acid PCM material and a conventional insulating material such as fiberglass. In other embodiments, the benzoic acid PCM thermal storage or temperature stabilization materials can be homogeneous, meaning that they are not incorporated into a mixture of materials, e.g. as a thermal energy layer comprised of benzoic acid within a package used to transport food, drinks, biological agents or reagents, pharmaceuticals, drugs and the like. In certain embodiments, the benzoic acid PCM thermal storage or temperature stabilization materials can be incorporated into existing thermal energy or temperature stabilization management systems, e.g. building insulation, coolers, containers, industrial thermals storage tanks, residential heating systems, or the like.

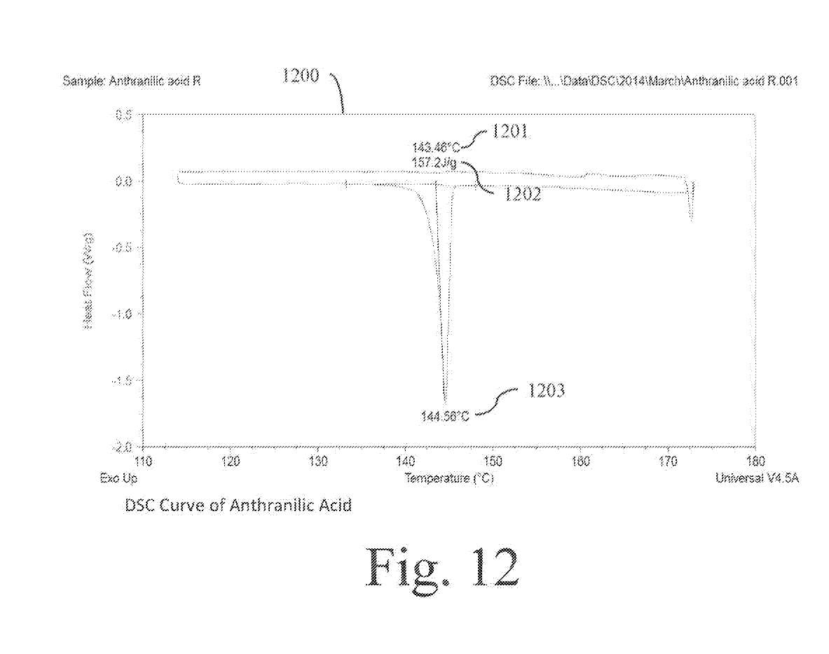

FIGS. 12 to 14 illustrate Differential Scanning calorimetry (DSC) scans of exemplary benzoic acids that may be used for thermal energy storage and/or temperature stabilization in alternative embodiments as provided herein, and show freezing temperature, melting point and latent heat. DSC scans describe: a freezing temperature of the material, as shown by a first peak with an area above the x-axis; and, a melting temperature of the material, as shown by a second peak with an area under the x-axis. Temperature differences between freezing and melting point can be due to a number of factors including supercooling and instrument functionality e.g. differences in the scan rate when measuring freezing and melting. The latent heat of the scanned material is measured by calculating the area under the curve of each of the freezing and melting peaks.

FIG. 12 shows a DSC curve 1200 of anthranilic acid with a measured latent heat 1202 of 157.2 J/g at a melting temperature 1203 of 144.56° C.

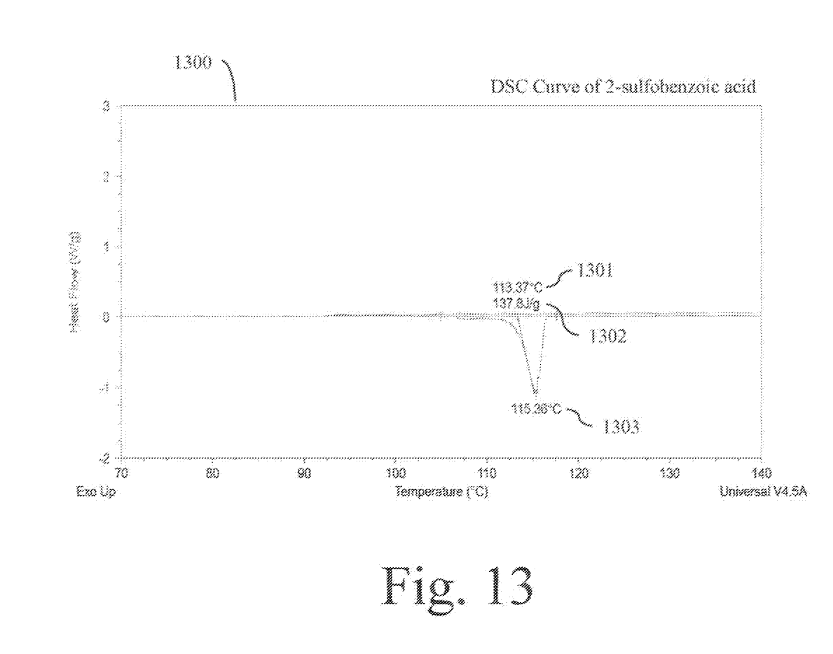

FIG. 13 shows a DSC curve 1300 of 2-sulfobenzoic acid with a measured latent heat 1302 of 137.8 J/g, and a melting temperature 1303 of 115.36° C.

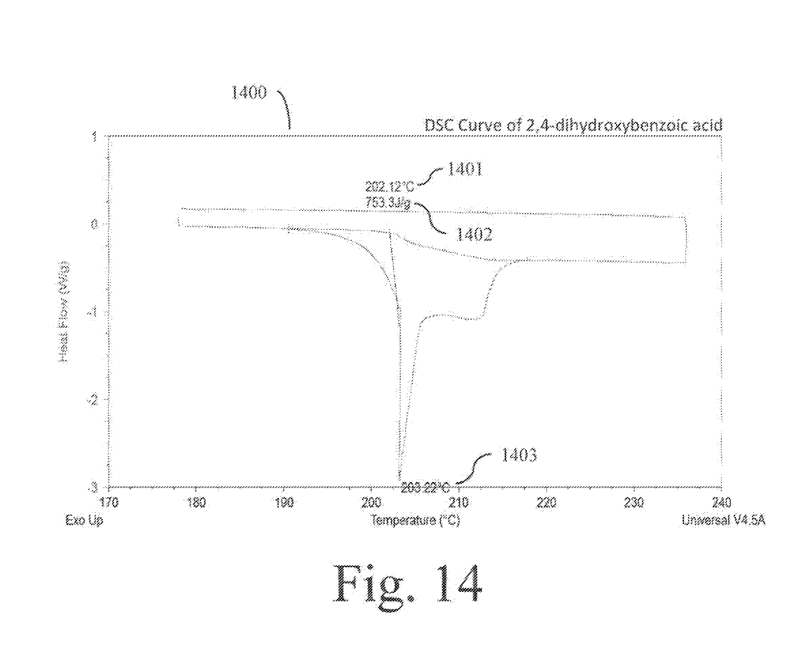

FIG. 14 shows a DSC curve 1400 of 2,4-dihydroxybenzoic acid with a measured latent heat 1402 of 753.3 J/g, and a melting temperature 1403 of 203.22° C.

While the forgoing written description of the invention enables one of ordinary skill to make and use what is considered presently to be the best mode thereof, those of ordinary skill will understand and appreciate the existence of variations, combinations, and equivalents of the specific embodiments, methods, and examples herein. The invention should therefore not be limited by the above described embodiments, methods and examples, but by all embodiments and methods within the scope and spirit of the invention.

A number of embodiments have been described. Nevertheless, it will be understood that various modifications may be made without departing from the spirit and scope of the invention. Accordingly, other embodiments are within the scope of the following claims.

1. A composition, a product of manufacture, or a thermal energy storage (TES) or temperature stabilization compound or system, comprising:
a Phase Change Material (PCM) compound selected from the group consisting of:
a triamine or triamine acid derivative; a nitrile or nitrile derivative; an anhydride or anhydride derivative; a benzoic acid or benzoic acid derivative; and a combination thereof;
wherein the phase change material compound is capable of undergoing a solid to liquid and a liquid to solid phase change transition.

2. The composition, product of manufacture, or thermal energy storage (TES) or temperature stabilization compound of claim 1, wherein the triamine or triamine acid derivative comprises an alkyl triamine or an aromatic triamine, or the triamine is selected from the group consisting of: a polyetheramines, an N-(2-aminoethyl)-1,3-propanediamine, a spermidine, bis(hexamethylene)triamine, a 3,3-diamnopropylamine and a combination thereof,
and optionally the triamine or triamine acid derivative, optionally a trialkyl amine, has a latent heat of fusion in the range of between about 186 and 257 J/g.

3. The composition, product of manufacture, or thermal energy storage (TES) or temperature stabilization compound or system of claim 1, wherein the nitrile or nitrile derivative is selected from the group consisting of: mononitriles, dinitriles, trinitriles, polynitriles and a combination thereof,
and optionally the nitrile or nitrile derivative, optionally an alkyl nitrile, has a latent heat of fusion in the range of between about 190 and 233 J/g.

4. The composition, product of manufacture, or thermal energy storage (TES) or temperature stabilization compound or system of claim 1, wherein the nitrile or nitrile derivative is, or comprises, an alkyl nitrile.

5. The composition, product of manufacture, or thermal energy storage (TES) or temperature stabilization compound or system of claim 1, wherein the nitrile or nitrile derivative is, or comprises, an aromatic nitrile.

6. The composition, product of manufacture, or thermal energy storage (TES) or temperature stabilization system or compound of claim 1, wherein the nitrile or nitrile derivative is selected from the group consisting of: tetradecanonitrile, heptadecanonitrile, nonadecanenitrile, dodecanenitrile and a combination thereof.

7. The composition, product of manufacture, or thermal energy storage (TES) or temperature stabilization compound or system of claim 1, wherein the nitrile or nitrile derivative is synthesized via a Kolbe nitrile synthesis method, or wherein the nitrile or nitrile derivative is synthesized via an ammonia method.

8. The composition, product of manufacture, or thermal energy storage (TES) or temperature stabilization compound or system of claim 1, wherein the nitrile or nitrile derivative is synthesized via a CSI method.

9. The composition, product of manufacture, or thermal energy storage (TES) or temperature stabilization compound or system of claim 1, wherein the wherein PCM compound comprises an anhydride or anhydride derivative,
and optionally the anhydride or anhydride derivative has a latent heat of fusion in the range of between about 190 and 233 J/g.

10. The composition, product of manufacture, or thermal energy storage (TES) or temperature stabilization compound or system of claim 1, wherein the anhydride or anhydride derivative is selected from the group consisting of:
(a) an organic acid anhydride, an alkyl anhydride, an aryl anhydride, a symmetrical anhydride, a (mixed) unsymmetrical anhydride, a polyanhydride and a combination thereof;
(b) an alkyl anhydride, optionally where R¹ and R² are independently the same or a different alkyl or aryl group of groups: 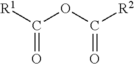
(c) an aryl anhydride where the ‘R’ groups independently are: an alkyl group, an aryl group, and a functional group; or, an alkyl anhydride comprising two aliphatic chains, where optionally ‘n’ is between 0 to 28: 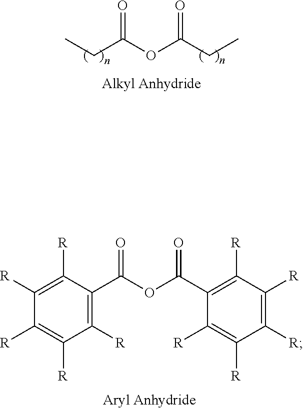
and
(d) any combination of (a) to (c).

11. The composition, a product of manufacture, or a thermal energy storage (TES) or temperature stabilization compound or system of claim 1, wherein the anhydride or anhydride derivative comprises: an acetic anhydride, a hexanoic anhydride, an octanoic anhydride, a decanoic anhydride, a dodecanoic anhydride, an octadecanoic anhydride, a cosanoic anhydride, a docosanoic anhydride, a hexacosanoic anhydride, or a tricosanioc anhydride.

12. The composition, a product of manufacture, or a thermal energy storage (TES) or temperature stabilization compound or system of claim 1, wherein the anhydride or anhydride derivative comprises: aryl (benzoic) anhydrides e.g. benzoic anhydride, 4-nitrobenzoic anhydride, perfluorobenzoic anhydride, 4-chlorobenzoic anhydride, 3-chlorobenzoic anhydride, 2-chlorobenzoic anhydride, 4-methoxybenzoic anhydride, 3,4-dimethoxybenzoic anhydride, 3,4,5-trimethoxybenzoic anhydride, 2,6-dichlorobenzoic anhydride, 3,5-dichlorobenzoic anhydride, 2-methylbenzoic anhydride, 3-methylbenzoic anhydride, 4-methylbenzoic anhydride, 4-aminobenzoic anhydride, 4-dimethylaminobenzoic anhydride, 3-dimethylaminobenzoic anhydride, 4-fluorobenzoic anhydride, 2-fluorobenzoic anhydride, 2-bromobenzoic anhydride, 4-bromobenzoic anhydride, 3-trifluoromethylbenzoic anhydride, 4-trifluoromethylbenzoic anhydride, 2-methyl-6-nitrobenzoic anhydride, or 2-amino-6-methylbenzoic anhydride.

13. The composition, a product of manufacture, or a thermal energy storage (TES) or temperature stabilization compound or system of claim 1, wherein the benzoic acid or benzoic acid derivative comprises a compound in the range of between about 137 to 753 J/g.

14. The composition, a product of manufacture, or a thermal energy storage (TES) or temperature stabilization compound or system of claim 1, wherein the benzoic acid or benzoic acid derivative is selected from the group consisting of:
(a) a benzoic acid having the formula: 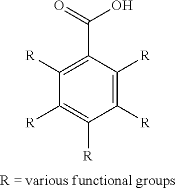
wherein the R functional groups independently are: a carboxy, ester, amide, hydroxyl, halide, ether, alkyl, phenyl, amino, cyano, nitro, thiol, or other functional group, and optionally the benzene ring is substituted with 2 to 6 similar or different substituents;
(b) a 2-hydroxybenzoic acid, 3-hydroxybenzoic acid. 4-hydroxybenzoic acid, 4-amino-2-hydroxybenzoic acid, 5-amino-2-hydroxybenzoic acid, 3-amino-2-methoxybenzoic acid, 2-hydroxy-5-nitrobenzoic acid, 2-chloro-5-nitrobenzoic acid, 3,5-dinitro-2-hydroxybenzoic acid, 2-hydroxy-3-methylbenzoic acid, 2-hydroxy-5-nitrobenzoic acid, 4-cyanobenzoic acid, 2-acetoxybenzoic acid, 3-acetoxybenzoic acid, 3-methoxy-4-methylbenzoic acid, 4-dimethylaminobenzoic acid, 3-methoxybenzoic acid, 3,4-dimethoxybenzoic acid, 3,5-dimethylbenzoic acid, 1,2-benzenedicarboxylic acid, 1,2,4-benzenetricarboxylic acid, or 1,2,4,5-benzenetetracarboxylic acid;
(c) an anthranilic acid, a 2,4-dihydroxybenzoic acid, or 2-sulfobenzoic acid; and
(d) any combination of (a) to (c).

15. A nanoparticle, a microparticle, a macroparticle, a liposome, a capsule, or a microcapsule comprising a phase change material-comprising composition of claim 1,
wherein optionally the nanoparticle, microparticle, macroparticle, liposome, capsule or microcapsule is multilayered, optionally with a different phase change material-comprising composition in each different layer.

16. An article of manufacture, a product of manufacture, a coating, a liquid, a gel, an antifreeze fluid, a fluid, an ink, an oil, a lubricant, a sealant, a paint, a textile, a cloth, a clothing, an upholstered furniture, a matting, a bedding or bedding system, a pharmaceutical or drug delivery system, a food or a food storage system, an electronic or computer hardware or systems or storage facilities, or a weapons system, comprising: a phase change material-comprising composition of claim 1,
wherein optionally the phase change material-comprising composition is a nanoparticle, a microparticle, a macroparticle, a liposome, a capsule, or a microcapsule comprising a composition of claim 1.

17. A building or an insulation material, an automotive or boat or airline material, a packaging material, a garment, a footwear or a footwear material, or an energy storage or temperature stabilization system, comprising: a phase change material-comprising composition of claim 1,
wherein optionally the phase change material-comprising composition is a nanoparticle, a microparticle, a macroparticle, a liposome, a capsule, or a microcapsule comprising a composition of claim 1.

18. The composition, a product of manufacture, or a thermal energy storage (TES) or temperature stabilization compound or system of claim 1, wherein the PCM comprises: a triamine and a nitrile, a triamine and an anhydride, a triamine and a benzoic acid, a nitrile and an anhydride; a nitrile and a benzoic acid, an anhydride and a benzoic acid.

19. The composition, a product of manufacture, or a thermal energy storage (TES) or temperature stabilization compound or system of claim 18, wherein the PCM comprises: a triamine; a nitrile; an anhydride; and a benzoic acid.

20. The composition, a product of manufacture, or a thermal energy storage (TES) or temperature stabilization compound or system of claim 1, comprising a Phase Change Material (PCM) compound comprising a triamine or triamine acid derivative.

21. The composition, a product of manufacture, or a thermal energy storage (TES) or temperature stabilization compound or system of claim 1, comprising a Phase Change Material (PCM) compound comprising a nitrile or nitrile derivative.

22. The composition, a product of manufacture, or a thermal energy storage (TES) or temperature stabilization compound or system of claim 1, comprising a Phase Change Material (PCM) compound comprising an anhydride or anhydride derivative.

23. The composition, a product of manufacture, or a thermal energy storage (TES) or temperature stabilization compound or system of claim 1, comprising a Phase Change Material (PCM) compound comprising a benzoic acid or benzoic acid derivative.
